(19) United States
(12) Patent Application Publication
(10) Pub. No.: US 2025/0292978 A1
(43) Pub. Date: Sep. 18, 2025

(54) MULTIFUNCTION SWITCH

(71) Applicant: MULLEN TECHNOLOGIES, INC., Brea, CA (US)

(72) Inventors: Aaron Marin, Lake Forest, CA (US); Robert Huotari, Irvine, CA (US); David Wayne Russell, Winter Garden, FL (US); Mohamed Shaib, Irvine, CA (US); Rodolfo Reyes Luna, Torrance, CA (US); Mario Alberto Rubio Monroy, Los Angeles, CA (US)

(73) Assignee: MULLEN TECHNOLOGIES, INC., Brea, CA (US)

(21) Appl. No.: 19/060,605

(22) Filed: Feb. 21, 2025

Related U.S. Application Data
(60) Provisional application No. 63/559,481, filed on Feb. 29, 2024.

(51) Int. Cl. H01H 25/00; H01H 25/04

(52) U.S. Cl. CPC H01H 25/008; H01H 25/041; H01H 2221/016

(57) ABSTRACT

Systems, methods, and computer-readable media for opening vehicle doors with a multifunction switch are provided. A multifunction switch of this disclosure may provide a unified system where multiple functions can be controlled from a single point, enhancing user experience and operational efficiency. Using a multifunction switch as a single unit, the latch can be operated either electrically or mechanically.

### CROSS REFERENCE TO RELATED APPLICATION(S)

This application claims the benefit of prior filed U.S. Provisional Patent Application No. 63/559,481, filed Feb. 29, 2024, which is hereby incorporated by reference herein in its entirety.

### COPYRIGHT NOTICE

At least a portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### TECHNICAL FIELD

This disclosure relates to multifunction switches and, more particularly, but without limitation, to multifunction switches for both mechanically and electrically controlling the opening of vehicle doors and methods for using the same.

### BACKGROUND OF THE DISCLOSURE

Conventional vehicle doors may be opened either by a mechanical feature or by a distinct electronic feature of an infotainment system.

### SUMMARY OF THE DISCLOSURE

This document describes systems, methods, and computer-readable media for opening vehicle doors with a multifunction switch. In some embodiments, there is provided a multifunction switch, as disclosed herein.

In some other embodiments, there is provided a method for using a multifunction switch, as disclosed herein.

In yet some other embodiments, there is provided a non-transitory computer-readable storage medium storing at least one program, the at least one program including instructions, which, when executed by at least one processor, cause the at least one processor to use a multifunction switch, as disclosed herein.

In yet some other embodiments, there is provided a vehicle that may include a barrier component, a compartment component defining a barrier opening, and a multifunction switch system that may include a barrier multifunction switch that may include a mechanical interface component that is configured to be moved from a first mechanical switch position to a second mechanical switch position and an electrical interface component coupled to the mechanical interface component, and a latch assembly that may be configured to enable movement of at least a portion of the barrier component away from the barrier opening in response to movement of the mechanical interface component from the first mechanical switch position to the second mechanical switch position and enable movement of at least the portion of the barrier component away from the barrier opening in response to an interface electrical signal being generated by the electrical interface component.

In yet some other embodiments, there is provided a vehicle that may include a barrier component, a compartment component, and a multifunction switch system that may include a barrier multifunction switch that may include a mechanical interface component that is configured to be moved from a first mechanical switch position to a second mechanical switch position and an electrical interface component coupled to a surface of the mechanical interface component, and a latch assembly that is configured to enable movement of at least the portion of the barrier component away from the compartment component in response to an interface electrical signal being generated by the electrical interface component.

In yet some other embodiments, there is provided a vehicle that may include a barrier component, a compartment component, and a multifunction switch system that may include a barrier multifunction switch and a latch assembly operable to move the barrier component away from the compartment component in response to mechanical movement of the barrier multifunction switch and move the barrier component away from the compartment component in response to an interface electrical signal generated by the barrier multifunction switch.

This Summary is provided to summarize some example embodiments, so as to provide a basic understanding of some aspects of the subject matter described in this document. Accordingly, it will be appreciated that the features described in this Summary are only examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The discussion below makes reference to the following drawings, in which like reference characters may refer to like parts throughout, and in which:

FIG. 1 is a schematic view of an illustrative system that may provide a vehicle management service, in accordance with some embodiments of the disclosure;

FIG. 1A is a more detailed schematic view of a subsystem of the system of FIG. 1, in accordance with some embodiments of the disclosure;

FIG. 1B is a more detailed schematic view of a portion of the system of FIG. 1, in accordance with some embodiments of the disclosure;

FIG. 1C is a more detailed schematic view of another portion of the system of FIG. 1, in accordance with some embodiments of the disclosure;

FIG. 2 is a top, left side, rear perspective view of a vehicle with a multifunction switch system, in accordance with some embodiments of the disclosure;

FIG. 2A is a left side view of a portion of the vehicle of FIG. 2, in accordance with some embodiments of the disclosure;

FIG. 2B is a right side view of a portion of the vehicle of FIG. 2, in accordance with some embodiments of the disclosure;

FIG. 2C is a rear view of a portion of the vehicle of FIG. 2, in accordance with some embodiments of the disclosure;

FIG. 2D is a top, left side, rear perspective view of a portion of a vehicle with a multifunction switch system, in accordance with some embodiments of the disclosure;

FIG. 2E is a top, right side, rear perspective view of a vehicle with a multifunction switch system, in accordance with some embodiments of the disclosure;

FIG. 2F is a top, right side, rear perspective view of a vehicle with a multifunction switch system, in accordance with some embodiments of the disclosure;

FIGS. 3 and 4 are perspective views of a multifunction switch interface of a multifunction switch system, with different levels of detail, in accordance with some embodiments of the disclosure;

FIG. 5 is a cross-sectional view of the multifunction switch interface of FIGS. 3 and 4, taken from line V-V of FIG. 4, in accordance with some embodiments of the disclosure;

FIGS. 6 and 6A-6D are cross-sectional views, similar to FIG. 5, of different types of switches of a multifunction switch interface, in accordance with some embodiments of the disclosure;

FIG. 6E is a diagram of a latch assembly of the multifunction switch interface of FIGS. 3-5, in accordance with some embodiments of the disclosure;

FIG. 7 is a perspective view of the multifunction switch interface of FIGS. 3-5, in accordance with some embodiments of the disclosure;

FIG. 8 is a cross-sectional view of the multifunction switch interface of FIGS. 3-5 and 7, taken from line VIII-VIII of FIG. 7, in accordance with some embodiments of the disclosure;

FIG. 8A is a diagram of a latch assembly of the multifunction switch interface of FIGS. 3-5, 7, and 8, in accordance with some embodiments of the disclosure;

FIG. 9 is a first block diagram of a multifunction switch system, in accordance with some embodiments of the disclosure;

FIG. 10 is a second block diagram of the multifunction switch system of FIG. 9, in accordance with some embodiments of the disclosure;

FIG. 11 is a cross-sectional view of another multifunction switch interface, in accordance with some embodiments of the disclosure;

FIG. 12 is a first block diagram of another multifunction switch system, in accordance with some embodiments of the disclosure;

FIG. 13 is a second block diagram of the multifunction switch system of FIG. 12, in accordance with some embodiments of the disclosure;

FIG. 14 is a first block diagram of yet another multifunction switch system, in accordance with some embodiments of the disclosure;

FIG. 15 is a second block diagram of the multifunction switch system of FIG. 14, in accordance with some embodiments of the disclosure;

FIG. 16 is a perspective view of an alternative multifunction switch interface, in accordance with some embodiments of the disclosure;

FIG. 16A is a cross-sectional view of the multifunction switch interface of FIG. 16, taken from line XVIA-XVIA of FIG. 16, in accordance with some embodiments of the disclosure;

FIG. 16B is a diagram of a latch assembly of the multifunction switch interface of FIGS. 16 and 16A, in accordance with some embodiments of the disclosure;

FIG. 17 is a first block diagram of yet another multifunction switch system, in accordance with some embodiments of the disclosure; and

FIG. 18 is a second block diagram of the multifunction switch system of FIG. 17, in accordance with some embodiments of the disclosure.

### DETAILED DESCRIPTION OF THE DISCLOSURE

Systems, methods, and computer readable media for opening vehicle doors with a multifunction switch are provided.

Electric and next-generation vehicles may include electronic latches that may enable major control through telematic and/or infotainment systems to manage the locking and/or unlocking of one or more doors, liftgate, hood, and/or any other suitable panel or component that can be opened/closed remotely (e.g., exterior door handle, charging cap, release handle, compartment glove box door, etc.). However, these latches may include a mechanical backup system that may be configured to function without electrical power, which may utilize a second feature in the cabin to activate it. Such mechanical and electrical latches may operate independently from one another or provide limited functionality when power is unavailable. These components may be implemented as separate parts or placed in different areas, which can lead to inefficiencies and inconvenience for users. Additionally or alternatively, auxiliary opening systems may tend to be hidden from view, making them difficult for users to locate and use intuitively without prior knowledge of the system. A multifunction switch of this disclosure may be configured to integrate these functions. A multifunction switch of this disclosure may provide a unified system where multiple functions can be controlled from a single point, enhancing user experience and operational efficiency. Using a multifunction switch as a single unit, the latch can be operated either electrically or mechanically. A multifunction switch of this disclosure may streamline the mechanical and electrical processes that may be involved in opening any suitable vehicle door or any other suitable barrier component for providing access to any suitable compartment component of any suitable vehicle (e.g., a passenger door barrier component to a passenger compartment component, a liftgate barrier component to a trunk compartment component, a hood barrier component to an engine compartment component, a charging cap barrier component to a charging compartment component, a fuel barrier component to a fuel compartment component, a glove box barrier component to a glove box compartment component, a center/door/floor console barrier component to a center/door/floor console compartment component, and/or the like of any suitable motor vehicle (e.g., car, truck, bus, motorcycle, etc.), railed vehicle (e.g., train, tram, etc.), watercraft (e.g., ship, boat, jet ski, etc.), aircraft (e.g., airplane, helicopter, drone, etc.), hover vehicle, spacecraft, a drone (e.g., a multirotor drone), and/or the like), such as from inside the vehicle. A multifunction switch of this disclosure may improve any suitable Class A surface function and/or consolidate the primary and secondary options for opening a powered latch assembly mechanism. A multifunction switch system of this disclosure may be equipped with a backup power system (“BPS”) that may be configured to ensure the multifunction switch system may continue to function even when a primary power source is unavailable. Additionally or alternatively, a multifunction switch system of this disclosure may include a mechanism that may be configured to activate automatically, deploying a mechanical lever to alert users of its presence. A multifunction switch system of this disclosure may be configured to provide seamless operation and enhance the user experience, reduce the effort required to activate these mechanisms, and make them more ergonomic and accessible to users. Many vehicles may include an electronic latch assembly and a secondary mechanical release mechanism, and there may be many features in the vehicle to control the switch and latch assembly (e.g., a Body Control Module, Vehicle Control Unit, Electronic Control Unit, Door/Liftgate Control Module, etc.). A multifunction switch system of this disclosure may enhance the convenience for vehicle passengers. It may integrate a multifunction switch that can be activated either electronically or mechanically. This switch may be configured to control the latch mechanisms or latch assemblies of various parts of the vehicle (e.g., latch mechanism(s) of any suitable barrier component for any suitable compartment component (e.g., passenger door, liftgate, hood, etc.)). A strategic significance of a multifunction switch of this disclosure may be to enhance users' ergonomics, haptic design, and overall safety when a vehicle is not powered. A multifunction switch of this disclosure may allow a vehicle's passengers to open a door, liftgate, and/or hood by activating a latch mechanism electronically or mechanically in a combined multifunction switch. A multifunction switch mechanism may be mounted at, in, or on any suitable vehicle interior surfaces, such as door panels, instrument panel, center console, door trim, overhead console, trunk, front storage compartment, liftgate, and/or the like. For example, a multifunction switch may be configured to interface with an electronic/mechanical latch assembly and vehicle control modules (e.g., door module, body control module, vehicle control unit, gateway unit, etc.). A control system may be designed to provide a backup power source and a self-presenting lever.

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

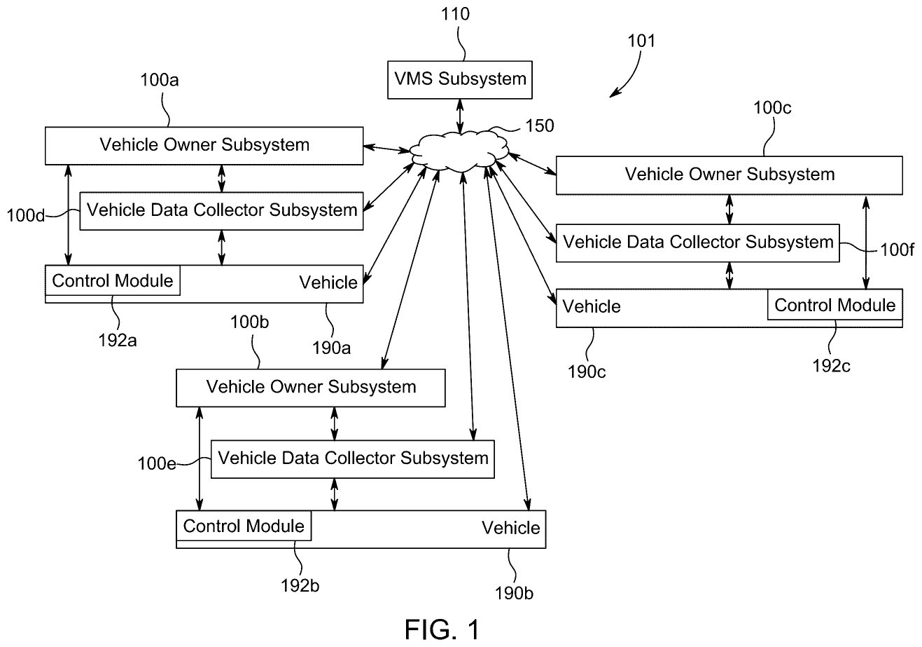

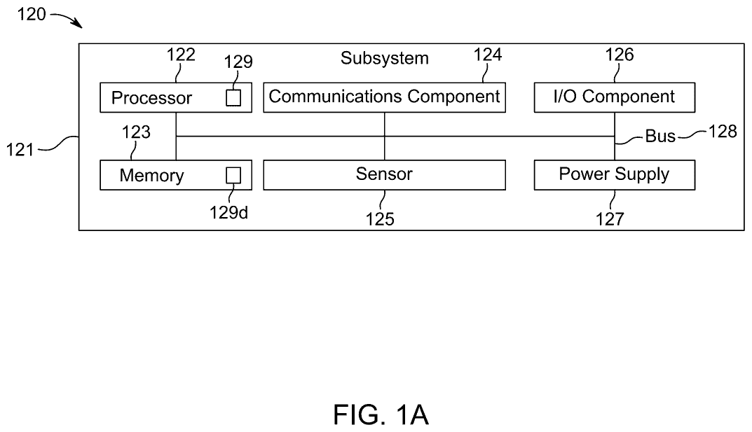

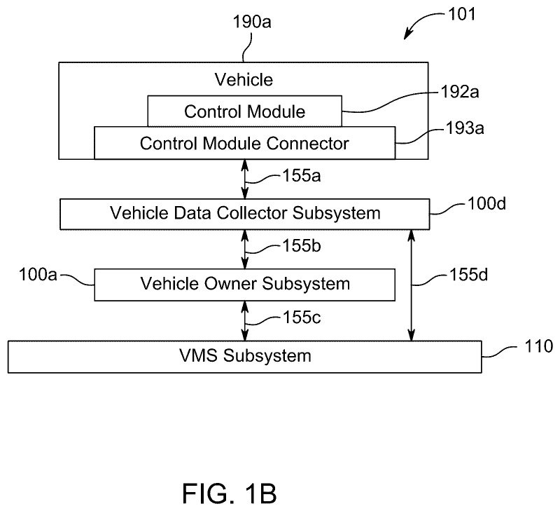

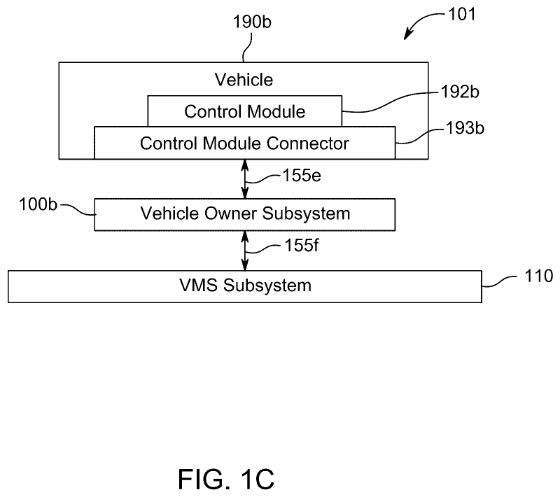

FIG. 1 is a schematic view of an illustrative system 101 in which a vehicle management service, including, but not limited to, a multifunction switch service, may be facilitated amongst one or more various entities. For example, as shown in FIG. 1, system 101 may include a vehicle management service (“VMS”) subsystem 110, various subsystems 100 (e.g., one or more vehicle owner (“VO”) subsystems 100a-100c, one or more vehicle data collector (“VDC”) subsystems 100d-100f, each of which may be communicatively coupled to one or more control modules (“CMs”) or subsystems 192 of a respective vehicle 190 (e.g., CMs 192a-192c of respective vehicles 190a-190c that may be owned or operated or managed or controlled by passengers or owners of respective vehicle owner subsystems 100a-100c), and at least one communications network 150 through which any two or more of the subsystems 100, 110, and 192 may communicate. VMS subsystem 110 may be operative to interact with any of the various subsystems 192 and 100, and/or any two or more subsystems 192 and 100 may be operative to interact with each other, to provide a vehicle management service platform (“VMSP”) that may facilitate various vehicle management services, including, but not limited to, managing and enhancing the vehicle utilization process for vehicle owners, users, buyers, sellers, and/or the like for enabling effective, efficient, safe, and enjoyable vehicle utilization.

As shown in FIG. 1A, and as described in more detail below, a subsystem 120, which may be exemplary of any one, some, or each of subsystem 110, subsystem 192a-192c, and/or subsystem 100a-100f, may include a processor component 122, a memory component 123, a communications component 124, a sensor component 125, an input/output (“I/O”) component 126, a power supply component 127, and/or a bus 128 that may provide one or more wired or wireless communication links or paths for transferring data and/or power to, from, or between various other components of subsystem 120. In some embodiments, one or more components of subsystem 120 may be combined or omitted. Moreover, subsystem 120 may include other components not combined or included in FIG. 1A and/or several instances of the components shown in FIG. 1A. For the sake of simplicity, only one of each of the components of subsystem 120 is shown in FIG. 1A.

I/O component 126 may include at least one input component (e.g., button, mouse, keyboard, etc.) to receive information from a user or other device or power therefrom and/or at least one output component (e.g., audio speaker, video display, haptic component, lighting element, movement actuator, etc.) to provide information or power or any other suitable support to a user or other device, such as a touch screen that may receive input information through a user's touch of a display screen and that may also provide visual information to a user via that same display screen, a multifunction switch, and/or the like. In some embodiments, an I/O component 126 may be any suitable data and/or power connector (e.g., a Universal Serial Bus (“USB”) connector or any other suitable connector type, a wireless charger (e.g., an inductive charging pad or the like), etc.) that may be utilized in any suitable manner by any suitable portable media device or the like.

Memory 123 may include one or more storage mediums or media, including for example, a hard-drive, flash memory, permanent memory such as read-only memory (“ROM”), semi-permanent memory such as random access memory (“RAM”), any other suitable type of storage component, or any combination thereof (e.g., for storing any suitable data (e.g., data 129d)).

Communications component 124 may be provided to allow subsystem 120 to communicate with one or more other subsystems 120 (e.g., any communication to/from/between subsystem(s) 110, 192, and 100 of system 101) using any suitable communications protocol(s). Communications component 124 can be operative to create or connect to a communication network or link of a network. Communications component 124 can provide wireless communications using any suitable short-range or long-range communications protocol, such as Wi-Fi (e.g., an 802.11 protocol), Bluetooth, ultra-wideband, radio frequency systems (e.g., 1200 MHZ, 2.4 GHz, and 5.6 GHz communication systems), near field communication (“NFC”), infrared, protocols used by wireless and cellular telephones and personal e-mail devices, or any other protocol supporting wireless communications. Communications component 124 can also be operative to connect to a wired communications link or directly to another data source wirelessly or via one or more wired connections or other suitable connection type(s). Communications component 124 may be a network interface that may include the mechanical, electrical, and/or signaling circuitry for communicating data over physical links that may be coupled to other devices of a network. Such network interface(s) may be configured to transmit and/or receive any suitable data using a variety of different communication protocols, including, but not limited to, TCP/IP, UDP, ATM, synchronous optical networks (“SONET”), any suitable wired protocols or wireless protocols now known or to be discovered, Frame Relay, Ethernet, Fiber Distributed Data Interface (“FDDI”), and/or the like. In some embodiments, one, some, or each of such network interfaces may be configured to implement one or more virtual network interfaces, such as for Virtual Private Network (“VPN”) access.

Sensor 125 may be any suitable sensor that may be configured to sense any suitable data for subsystem 120 (e.g., location-based data via a GPS (“Global Positioning System”) sensor system, motion data, environmental data, biometric data, etc.). Sensor 125 may be a sensor assembly that may include any suitable sensor or any suitable combination of sensors operative to detect movements of subsystem 120 and/or of any user thereof and/or any other characteristics of subsystem 120 and/or of its environment (e.g., physical activity or other characteristics of a user of subsystem 120, light content of the environment of subsystem 120, gas content of the environment of subsystem 120, noise content of the environment of subsystem 120, altitude of subsystem 120, speed of subsystem 120, etc.). Sensor 125 may include any suitable sensor(s), including, but not limited to, one or more of a GPS sensor, wireless communication sensor, accelerometer, directional sensor (e.g., compass), gyroscope, motion sensor, pedometer, passive infrared sensor, ultrasonic sensor, microwave sensor, a tomographic motion detector, a camera, a biometric sensor, a light sensor, a timer, or the like. Sensor 125 may include any suitable sensor components or subassemblies for detecting any suitable movement of subsystem 120 and/or of a user thereof. For example, sensor 125 may include one or more three-axis acceleration motion sensors (e.g., an accelerometer) that may be operative to detect linear acceleration in three directions (i.e., the Y- or left/right direction, the Z- or up/down direction, and the X- or forward/backward direction). As another example, sensor 125 may include one or more single-axis or two-axis acceleration motion sensors that may be operative to detect linear acceleration only along each of the Y- or left/right direction and the Z- or up/down direction, or along any other pair of directions. In some embodiments, sensor 125 may include an electrostatic capacitance (e.g., capacitance-coupling) accelerometer that may be based on silicon micro-machined micro electro-mechanical systems (“MEMS”) technology, including a heat-based MEMS type accelerometer, a piezoelectric type accelerometer, a piezo-resistance type accelerometer, and/or any other suitable accelerometer (e.g., which may provide a pedometer or other suitable function). Sensor 125 may be operative to directly or indirectly detect rotation, rotational movement, angular displacement, tilt, position, orientation, motion along a non-linear (e.g., arcuate) path, or any other non-linear motions. Additionally or alternatively, sensor 125 may include one or more angular rate, inertial, and/or gyro-motion sensors or gyroscopes for detecting rotational movement. For example, sensor 125 may include one or more rotating or vibrating elements, optical gyroscopes, vibrating gyroscopes, gas rate gyroscopes, ring gyroscopes, magnetometers (e.g., scalar or vector magnetometers), compasses, and/or the like. Any other suitable sensors may also or alternatively be provided by sensor 125 for detecting motion on subsystem 120, such as any suitable pressure sensors, altimeters, or the like. Using sensor 125, subsystem 120 may be configured to determine a velocity, acceleration, orientation, and/or any other suitable motion attribute of subsystem 120 (e.g., a direction and/or strength of an impact (e.g., a crash involving a vehicle 190). One or more biometric sensors may be multi-modal biometric sensors and/or operative to detect long-lived biometrics, modern liveness (e.g., active, passive, etc.) biometric detection, and/or the like. Sensor 125 may include a microphone, camera, scanner (e.g., a barcode scanner or any other suitable scanner that may obtain product identifying information from a code, such as a linear barcode, a matrix barcode (e.g., a quick response (“QR”) code), or the like), proximity sensor, light detector, temperature sensor, motion sensor, biometric sensor (e.g., a fingerprint reader or other feature (e.g., facial or gait) recognition sensor, which may operate in conjunction with a feature-processing application that may be accessible to subsystem 120 for attempting to authenticate a user), line-in connector for data and/or power, and/or combinations thereof. In some examples, each sensor can be a separate device, while, in other examples, any combination of two or more of the sensors can be included within a single subsystem or device. For example, a gyroscope, accelerometer, photoplethysmogram, galvanic skin response sensor, and temperature sensor can be included within a wearable electronic device, such as a smart watch, while a scale, blood pressure cuff, blood glucose monitor, SpO2 sensor, respiration sensor, posture sensor, stress sensor, and asthma inhaler can each be separate devices. While specific examples are provided, it should be appreciated that other sensors can be used and other combinations of sensors can be combined into a single subsystem or device. Subsystem 120 can further include a timer that can be used, for example, to add time dimensions to various attributes of any detected element(s). Sensor 125 may include any suitable sensor components or subassemblies for detecting any suitable characteristics of any suitable condition of the lighting of the environment of subsystem 120. For example, sensor 125 may include any suitable light sensor that may include, but is not limited to, one or more ambient visible light color sensors, illuminance ambient light level sensors, ultraviolet (“UV”) index and/or UV radiation ambient light sensors, and/or the like. Any suitable light sensor or combination of light sensors may be provided for determining the illuminance or light level of ambient light in the environment of subsystem 120 (e.g., in lux or lumens per square meter, etc.) and/or for determining the ambient color or white point chromaticity of ambient light in the environment of subsystem 120 (e.g., in hue and colorfulness or in x/y parameters with respect to an x-y chromaticity space, etc.) and/or for determining the UV index or UV radiation in the environment of subsystem 120 (e.g., in UV index units, etc.). Sensor 125 may include any suitable sensor components or subassemblies for detecting any suitable characteristics of any suitable condition of the air quality of the environment of subsystem 120. For example, sensor 125 may include any suitable air quality sensor that may include, but is not limited to, one or more ambient air flow or air velocity meters, ambient oxygen level sensors, volatile organic compound (“VOC”) sensors, ambient humidity sensors, ambient temperature sensors, and/or the like. Any suitable ambient air sensor or combination of ambient air sensors may be provided for determining the oxygen level of the ambient air in the environment of subsystem 120 (e.g., in O₂% per liter, etc.) and/or for determining the air velocity of the ambient air in the environment of subsystem 120 (e.g., in kilograms per second, etc.) and/or for determining the level of any suitable gas or potentially harmful substance (e.g., VOC (e.g., any suitable gasses, scents, odors, etc.) or particulate or dust or pollen or mold or the like) of the ambient air in the environment of subsystem 120 (e.g., in HG % per liter, etc.) and/or for determining the humidity of the ambient air in the environment of subsystem 120 (e.g., in grams of water per cubic meter, etc. (e.g., using a hygrometer)) and/or for determining the temperature of the ambient air in the environment of subsystem 120 (e.g., in degrees Celsius, etc. (e.g., using a thermometer)). Sensor 125 may include any suitable sensor components or subassemblies for detecting any suitable characteristics of any suitable condition of the sound quality of the environment of subsystem 120. For example, sensor 125 may include any suitable sound quality sensor that may include, but is not limited to, one or more microphones or the like that may determine the level of sound pollution or noise in the environment of subsystem 120 (e.g., in decibels, etc.). Sensor 125 may also include any other suitable sensor for determining any other suitable characteristics about a user of subsystem 120 and/or the environment of subsystem 120 and/or any situation within which subsystem 120 may exist. For example, any suitable clock and/or position sensor(s) may be provided to determine the current time and/or time zone within which subsystem 120 may be located. Sensor 125 may be embedded in a body (e.g., housing 121) of subsystem 120, such as along a bottom surface that may be operative to contact a user, or can be positioned at any other desirable location. In some examples, different sensors can be placed in different locations inside or on the surfaces of subsystem 120 (e.g., some located inside housing 121 (e.g., any suitable component of a vehicle (e.g., along an interior and/or exterior surface of a vehicle door, roof, rack and/or the like)), some coupled to or otherwise provided by an attachment mechanism (e.g., a wrist band coupled to a housing of a wearable device), and/or the like). In other examples, one or more sensors can be worn by a user separately as different parts of a single subsystem 120 or as different subsystems or devices. In such cases, the sensors can be configured to communicate with subsystem 120 using a wired and/or wireless technology (e.g., via communications component 124). In some examples, sensors can be configured to communicate with each other and/or share data collected from one or more sensors.

Power supply 127 can include any suitable circuitry for receiving and/or generating power, and for providing such power to one or more of the other components of subsystem 120. For example, power supply assembly 127 can be coupled to a power grid (e.g., when subsystem 120 is not acting as a portable device or when a battery of the device is being charged at an electrical outlet with power generated by an electrical power plant). As another example, power supply assembly 127 may be configured to generate power from a natural source (e.g., solar power using solar cells). As another example, power supply assembly 127 can include one or more batteries for providing power (e.g., when subsystem 120 is acting as a portable device). Subsystem 120 may also be provided with a housing 121 that may at least partially enclose one or more of the components of subsystem 120 for protection from debris and other degrading forces external to subsystem 120. Each component of subsystem 120 may be included in the same housing 121 (e.g., as a single unitary device, such as a portable media device or server) and/or different components may be provided in different housings (e.g., a keyboard input component may be provided in a first housing that may be communicatively coupled to a processor component and a display output component that may be provided in a second housing, such as in a desktop computer set-up). In some embodiments, subsystem 120 may include other components not combined or included in those shown or several instances of the components shown.

Processor 122 may be used to run one or more applications, such as an application 129 that may be accessible from memory 123 (e.g., as a portion of data 129d) and/or any other suitable source (e.g., from any other device in its system). Application 19 may include, but is not limited to, one or more operating system applications, firmware applications, communication applications (e.g., for enabling communication of data between devices), third party service applications, internet browsing applications (e.g., for interacting with a website provided by a third party subsystem), application programming interfaces (“APIs”), software development kits (“SDKs”), proprietary applications (e.g., a web application or a native application) for enabling subsystem 120 to interact with an online service and/or one or more other subsystems and/or the like, which may include applications for routing protocols, SDN modules based on OpenFlow,

P4, or other network data plane programming standards, machine learning algorithms, network management functions, etc., any other suitable applications, and/or the like. For example, processor 122 may load an application 129 as an interface program to determine how instructions or data received via an input component of I/O component 126 or other component of subsystem 120 (e.g., sensor 125 and/or communications component 124) may manipulate the way in which information may be stored (e.g., in memory 123) and/or provided via an output component of I/O component 126 (e.g., presented to a user on a display or actuator manipulation to adjust the position of any suitable component (e.g., seat, etc.)) and/or communicated to another system device via communications component 124. As one example, application 129 may be firmware. As another example, application 129 may be a third party application that may be running on subsystem 120 (e.g., an application associated with the network of system 101) that may be loaded on subsystem 120 in any suitable manner, such as via an application market (e.g., using communications component 124), such as the Apple App Store or Google Play, or that may be accessed via an internet application or web browser (e.g., by Apple Safari or Google Chrome) that may be running on subsystem 120 and that may be pointed to a uniform resource locator (“URL”) whose target or web resource may be managed by or otherwise affiliated with any suitable entity. Any subsystem may include any suitable special purpose hardware (e.g., hardware support of high-speed packet processing, hardware support of machine learning algorithms, etc.).

Subsystem 120 may be any portable, mobile, wearable, implantable, or hand-held electronic device configured to operate with system 101. Alternatively, subsystem 120 may not be portable during use, but may instead be generally fixed (e.g., permanently coupled to a vehicle or in a server center or the like). Subsystem 120 can include, but is not limited to, a media player, video player, still image player, game player, other media player, music recorder, movie or video camera or recorder, still camera, other media recorder, radio, medical equipment, domestic appliance, smart appliance (e.g., smart door knob, smart door lock, etc.), transportation vehicle instrument, musical instrument, calculator, cellular telephone, other wireless communication device, personal digital assistant, remote control, pager, computer (e.g., a desktop, laptop, tablet, server, etc.), monitor, television, stereo equipment, set up box, set-top box, wearable device, boom box, modem, router, printer, kiosk, beacon, server, object (e.g., door, roof, rack) repositioning management system, and any combinations thereof.

In some embodiments, processor 122 may be used to run one or more applications that may be accessible from memory 123 and/or from any other suitable source (e.g., an application from VMS subsystem 110 via an active internet connection or otherwise at and for use by a subsystem 100). Such an application may include, but is not limited to, one or more operating system applications, firmware applications, communication applications, internet browsing applications (e.g., for interacting with a website provided by VMS subsystem 110 for enabling a subsystem 192 or 100 to interact with an online service of VMS subsystem 110 (e.g., a VMSP)), VMS applications (e.g., a web application or a native application or a hybrid application that may be at least partially produced by VMS subsystem 110 for enabling a subsystem 192 or 100 to interact with an online service of VMS subsystem 110 (e.g., a VMSP)), or any other suitable applications. As one example, an application of a subsystem 100 may provide a user or a communicatively coupled device (e.g., control module 192) with the ability to interact with a vehicle management service or the VMSP of VMS subsystem 110, where such an application may be a third party application that may be running on a subsystem 100 (e.g., an application (e.g., software and/or firmware) associated with VMS subsystem 110 that may be loaded on subsystem 100 from VMS subsystem 110 or via an application market) and/or that may be accessed via an internet application or web browser running on subsystem 100 (e.g., processor 122) that may be pointed to a uniform resource locator (“URL”) whose target or web resource may be managed by VMS subsystem 10 or any other remote subsystem. One, some, or each subsystem 100 may be a portable media device (e.g., a smartphone), a laptop computer, a tablet computer, a desktop computer, an appliance, a wearable electronic device, a virtual reality device, a dongle device, at least one web or network server (e.g., for providing an online resource, such as a website or native online application, for presentation on one or more other subsystems) with an interface for an administrator of such a server, and/or the like.

Some or all portions of VMS subsystem 110 may be operated, managed, or otherwise at least partially controlled by an entity (e.g., administrator) responsible for providing a vehicle management service to one or more clients or other suitable entities. VMS subsystem 110 may communicate with one or more subsystems 100 via communications network 150. Network 150 may be the internet or any other suitable network, such that when intercoupled via network 150, any two subsystems of system 101 may be operative to communicate with one another (e.g., a subsystem 192 or 100 may access information (e.g., from an application 129 or data 129d of

VMS subsystem 110, as may be provided as a vehicle management service via processor 122 and communications component 124 of VMS subsystem 110) as if such information were stored locally at that subsystem (e.g., in its memory component 123)).

Various clients and/or partners may be enabled to interact with VMS subsystem 110 for enabling the vehicle management services and the VMSP. For example, at least one vehicle owner subsystem of system 101 (e.g., each one of the one or more vehicle owner subsystems 100a-100c) may be any suitable subsystem (e.g., portable computer and/or infotainment or other suitable device that may be fixed or removably coupled to a vehicle for use by its passenger(s)) operated by any suitable vehicle owner (“VO”) that may own, rent, or otherwise have access to (e.g., appropriately use) a vehicle (e.g., a respective one of the one or more vehicles 190a-190c (e.g., any suitable motor vehicle (e.g., car, truck, bus, motorcycle, etc.), railed vehicle (e.g., train, tram, etc.), watercraft (e.g., ship, boat, jet ski, etc.), aircraft (e.g., airplane, helicopter, drone, etc.), hover vehicle, spacecraft, a drone (e.g., a multirotor drone), and/or the like)). At least one vehicle data collector subsystem of system 101 (e.g., each one of the one or more vehicle data collector subsystems 100d-100f) may be any suitable subsystem (e.g., dongle device) that may be communicatively coupled to a respective vehicle owner subsystem (e.g., via a network 150) and to a respective control module (e.g., via direct installation) of a respective vehicle (e.g., VDC subsystem 100d may be communicatively coupled to VO subsystem 100a and to CM 192a of vehicle 190a that may be owned by the operator of VO subsystem 100a, VDC subsystem 100e may be communicatively coupled to VO subsystem 100b and to CM 192b of vehicle 90b that may be owned by the operator of VO subsystem 100b, and VDC subsystem 100f may be communicatively coupled to VO subsystem 100c and to CM 192c of vehicle 190c that may be owned by the operator of VO subsystem 100c). For example, a VDC subsystem may be any suitable on-board diagnostics (“OBD”) device that may be operative to be communicatively coupled with any suitable control module of any suitable vehicle (e.g., via any suitable OBD-II data link connector of a vehicle (e.g., via a physical connection or wireless path)) that may be operative to monitor any suitable data from an engine control unit and/or electronic control unit (“ECU”) of the vehicle and/or from any other data source of the vehicle that may be made available (e.g., according to the OBD protocol), such as a powertrain control module (“PCM”) or otherwise. A VDC subsystem may be operative to send one or more requests to the CM of a vehicle for one or more specific parameters using one or more specific parameter identification numbers (“PIDs”) (e.g., according to the Society of Automotive Engineers (“SAE”) standard J1979) and then the VDC subsystem may communicate any received parameter data from the vehicle to a VO subsystem that may be communicatively coupled to the VDC subsystem (e.g., via any suitable wired or wireless communication protocol). For example, as shown in FIG. 1B, VDC subsystem 100d may be communicatively coupled to any suitable control module connector 193a via any suitable communications path 155a, which may be a direct physical connection between connector 193a and a connector of VDC subsystem 100d (e.g., a male connector of an I/O component 126 of VDC subsystem 100d may physically mate with a female control module connector 93a (e.g., any suitable OBD-II data link connector)) or any suitable wireless connection, where control module connector 193a may be communicatively coupled to one, some, or all suitable control modules or data sources (e.g., control module 192a) of vehicle 190a, while VDC subsystem 100d may be communicatively coupled to VO subsystem 100a via any suitable communications path 155b (e.g., any suitable wired or wireless communications path using any suitable communications protocol (e.g., Bluetooth between a communications component 124 of VDC subsystem 100d and a communications component 124 of VO subsystem 100a)), while VO subsystem 100a may be communicatively coupled to VMS subsystem 110 via any suitable communications path 155c (e.g., any suitable wired or wireless communications path (e.g., of network 150 of FIG. 1) using any suitable communications protocol). Alternatively or additionally, as shown in FIG. 1B, VDC subsystem 100d may be communicatively coupled to VMS subsystem 110 via any suitable communications path 155d (e.g., any suitable wired or wireless communications path (e.g., of network 150 of FIG. 1) using any suitable communications protocol (e.g., any suitable long-range communications protocol between a communications component 124 of VDC subsystem 100d and a communications component 124 of VMS subsystem 110 (e.g., using a low power communications component and/or any suitable telemetry functionality)) without VO subsystem 100a as an intermediary). Additionally or alternatively, in some embodiments, a VO subsystem may be configured to communicate directly with a CM of a vehicle without the need for a distinct intermediary VDC subsystem. For example, as shown in FIG. 1C, VO subsystem 100b may be communicatively coupled to any suitable control module connector 193b via any suitable communications path 155e, which may be a direct wired connection between connector 193b and a connector of VO subsystem 100b (e.g., a connector of an I/O component 126 of VO subsystem 100b may be communicatively coupled to a first connector of a cable of communications path 155e and a second connector of such a cable may be communicatively coupled with control module connector 193b (e.g., any suitable OBD-II data link connector)) or any suitable wireless path, where control module connector 193b may be communicatively coupled to one, some, or all suitable control modules or data sources (e.g., control module 192b) of vehicle 190b, while VO subsystem 100b may be communicatively coupled to VMS subsystem 110 via any suitable communications path 155f (e.g., any suitable wired or wireless communications path (e.g., of network 150 of FIG. 1) using any suitable communications protocol). In some embodiments, communications path 155e may be a wireless communications path between control module 192b and VO subsystem 100b (e.g., a wireless (e.g., Bluetooth) communication path between a communications component 124 of VO subsystem 100b and a communications component of control module 192b of vehicle 190b), such that a data connection may be facilitated directly between a user's portable electronic device and a computer of a vehicle directly through a wireless connection.

Each subsystem 192 and 100 of system 101 (e.g., each one of subsystems 192a-192c and 100a-100f) may be operated by any suitable entity for interacting in any suitable way with VMS subsystem 110 (e.g., via network 150) for deriving value from and/or adding value to a service of the VMSP of VMS subsystem 110. For example, a particular subsystem 100 may be a server operated by a client/partner entity that may receive any suitable data from VMS subsystem 110 related to any suitable vehicle management enhancement of the VMSP provided by VMS subsystem 10 (e.g., via network 150). Additionally or alternatively, a particular subsystem 100 may be a server operated by a client/partner entity that may upload or otherwise provide any suitable data to VMS subsystem 110 related to any suitable vehicle management service of the VMSP provided by VMS subsystem 110 (e.g., via network 150).

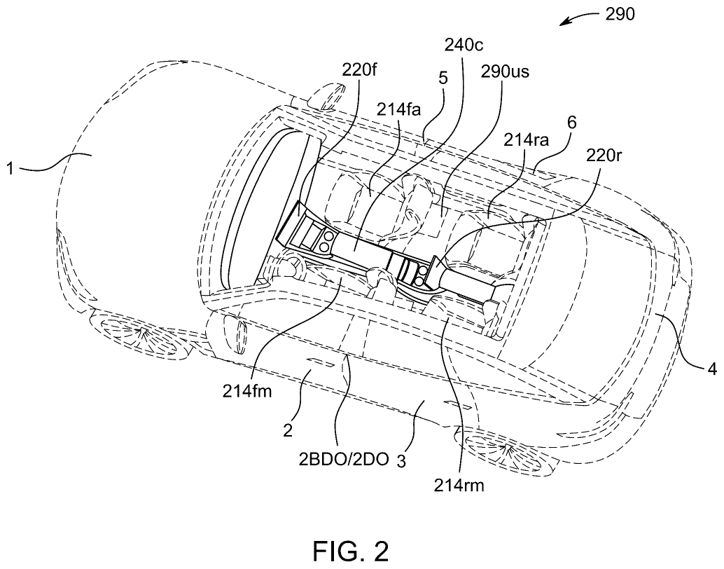

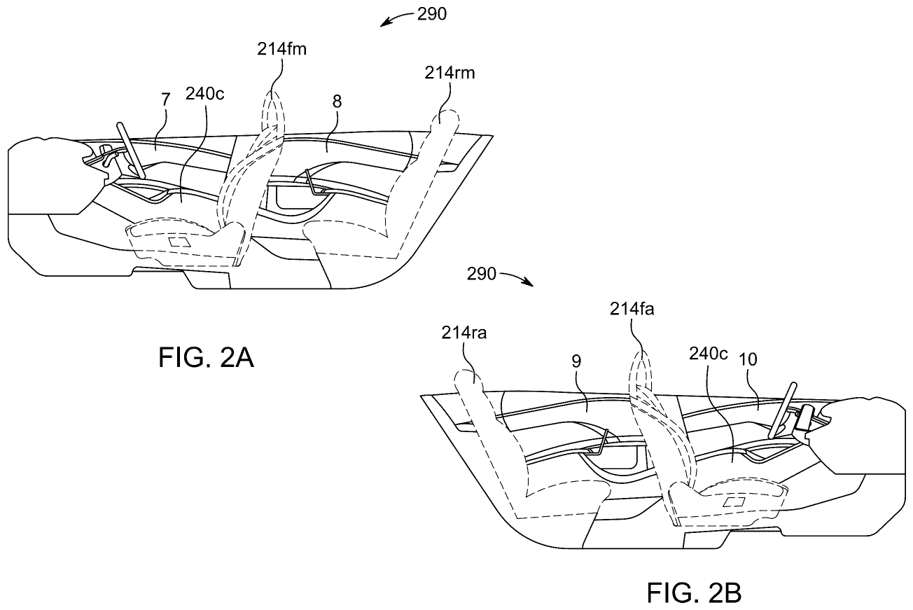

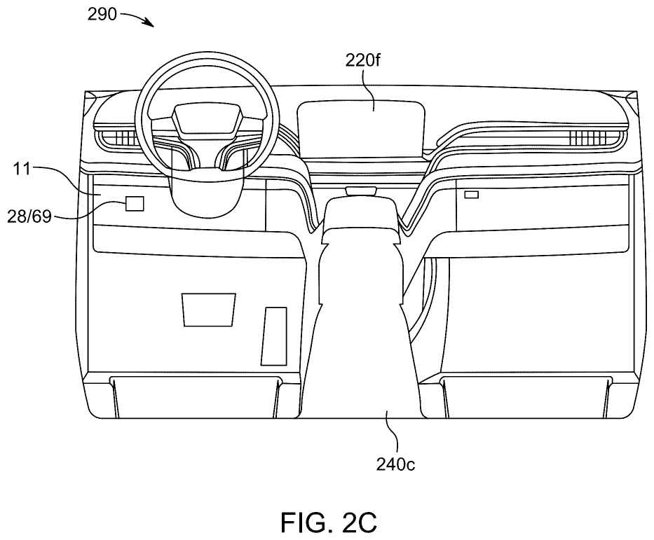

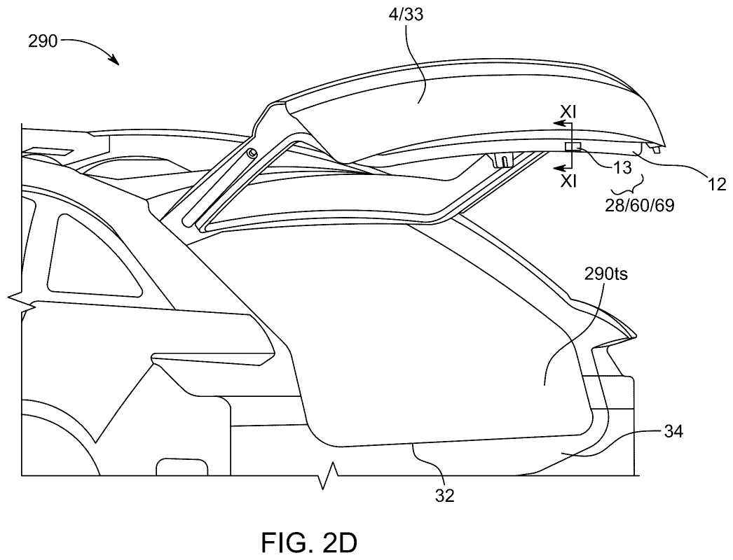

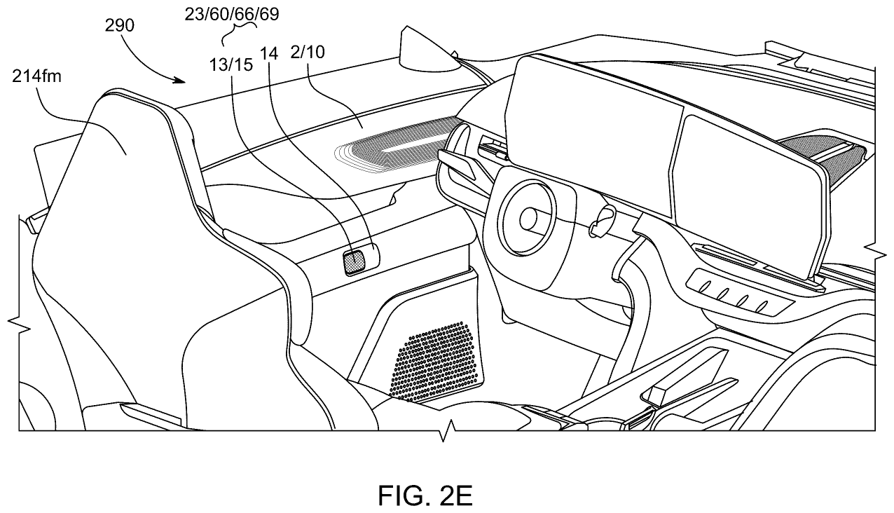

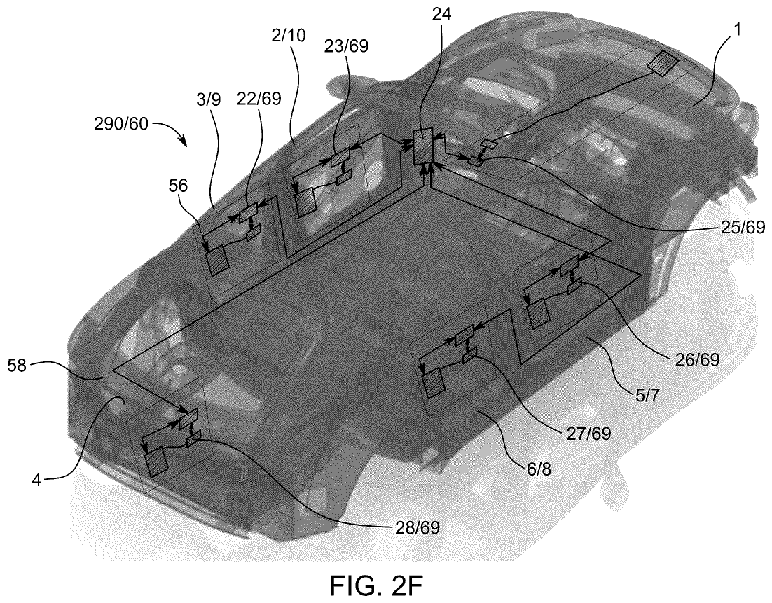

FIGS. 2 and 2A-2F show an illustrative vehicle 290 that may include at least one multifunction switch system 60, in accordance with various embodiments of the disclosure, which may be similar to any suitable subsystem 120 and/or which may incorporate or utilize any suitable subsystem(s) of the vehicle. Vehicle 290 may be any suitable vehicle, which may be similar to any vehicle 190 (e.g., vehicles 190a-190c) described herein. In some embodiments, as shown, vehicle 290 may be any suitable automobile with at least one seat that may be used by any suitable user. For example, as shown, vehicle 290 may include at least a front main seat 214fm (e.g., a driver seat if the vehicle is able to be driven) for a front main passenger (not shown). Additionally, in some embodiments, as shown, vehicle 290 may also include at least one front auxiliary seat 214fa for a front auxiliary passenger (not shown), and at least one rear seat for one or more rear passengers, such as a rear main seat 214rm for a rear main passenger (not shown) and/or a rear auxiliary seat 214ra for a rear auxiliary passenger (not shown). Although each seat for each passenger may be distinct in one or more ways from one another, any vehicle may be provided with a single seat that may be used simultaneously by two or more adjacent passengers (e.g., a bench type rear seat). A center console 240c may extend between seats 214fm and 214fa if not also between seats 214rm and 214ra.

Vehicle 290 may include any suitable vehicle information subsystem(s) 220, such as a front vehicle information subsystem 220f, a rear vehicle information subsystem 220r, and/or the like, one, some, or each of which may be communicatively coupled to a multifunction switch and/or may be operative to receive any suitable input instructions from a user or otherwise (e.g., via any suitable input component and/or sensor) and, in response, generate any suitable output control instruction(s), and then communicate such output control instruction(s).

Vehicle 290 may include at least one door (e.g., exterior door). For example, as shown in FIG. 2, in some embodiments, vehicle 290 may include at least one passenger door for selectively providing a user access to a passenger cabin space 290us provided by the vehicle, a trunk door for selectively providing access to a cargo or trunk space 290ts provided by the vehicle, a charging/fuel door for selectively providing access to a fuel tank or battery of the vehicle, and/or the like (see, e.g., a hood or hood barrier component 1 for any suitable engine compartment component, a driver-side front door or driver-side front door barrier component 2 for passenger cabin space 290us, a driver-side rear door or driver-side rear door barrier component 3 for passenger cabin space 290us, a trunk or liftgate barrier component 4 for any suitable trunk space or trunk compartment component 290ts, a passenger-side front door or passenger-side front door barrier component 5 for passenger cabin space 290us, a passenger-side rear door or passenger-side rear door barrier component 6 for passenger cabin space 290us, and/or the like). The vehicle may be equipped with advanced telematics controls. They may be configured to guide the routing action for the multifunction switch, ensuring a seamless and interactive experience for the occupants (see, e.g., FIGS. 2F, 9, and 10).

FIGS. 2A and 2B may provide a detailed view of both the passenger-side and driver-side door trims. A passenger-side front door trim 7 and a passenger-side rear door trim 8 may be shown in FIG. 2A, while a driver-side front door trim 10 and a driver-side rear door trim 9 may be shown in FIG. 2B. A feature of one or more of the door trims may be their ergonomic design, which may include a dedicated zone for a multifunction switch. This switch may be instrumental in activating the door opening release system, thereby allowing for easy operation of the doors (e.g., doors 2, 3, 5, 6, and/or any other suitable barrier component(s)). There may be one multifunction switch per door trim or there may be more or fewer. Its shape may be unique (e.g., a symmetrical mirror).

FIG. 2C may show an instrument panel 11 and any suitable center information display (e.g., a display of front vehicle information subsystem 220f). Panel 11 may be an ergonomic zone useful for placing a multifunction switch for activating a hood and/or a liftgate and/or a fuel/power cap. Panel 11 and a display of subsystem 220f (e.g., a display, touch screen, or any other suitable UI (e.g., I/O component(s) 126) of any suitable subsystem 220) may be strategically positioned in an ergonomic zone that may be accessible and intuitive for a user (e.g., driver, front passenger, etc.). A multifunction switch may be located within this zone, designed for ease of use, enabling the activation of a hood, liftgate, power cap, and/or any other suitable barrier component for enabling access to any associated compartment component of the vehicle.

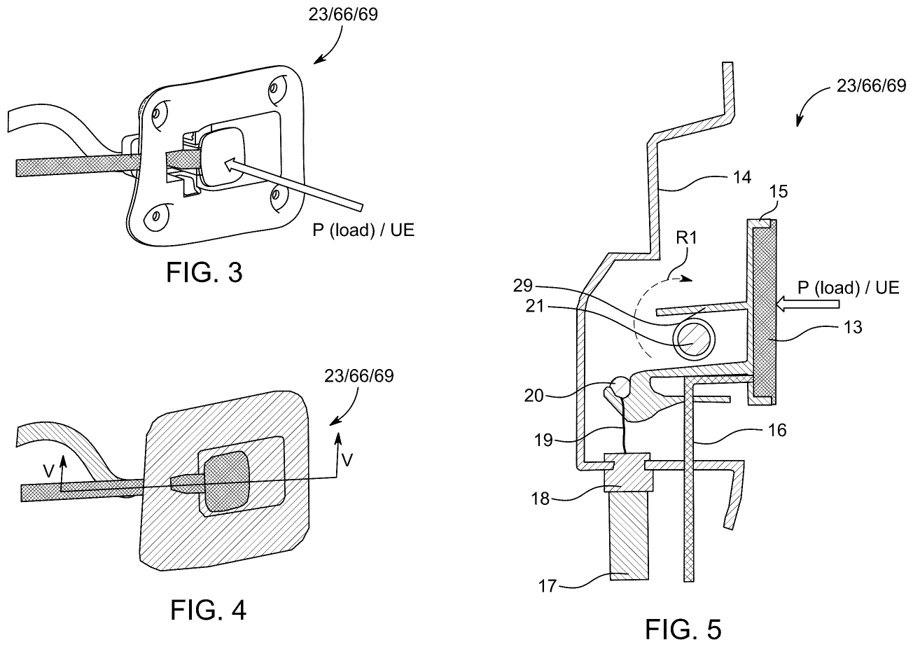

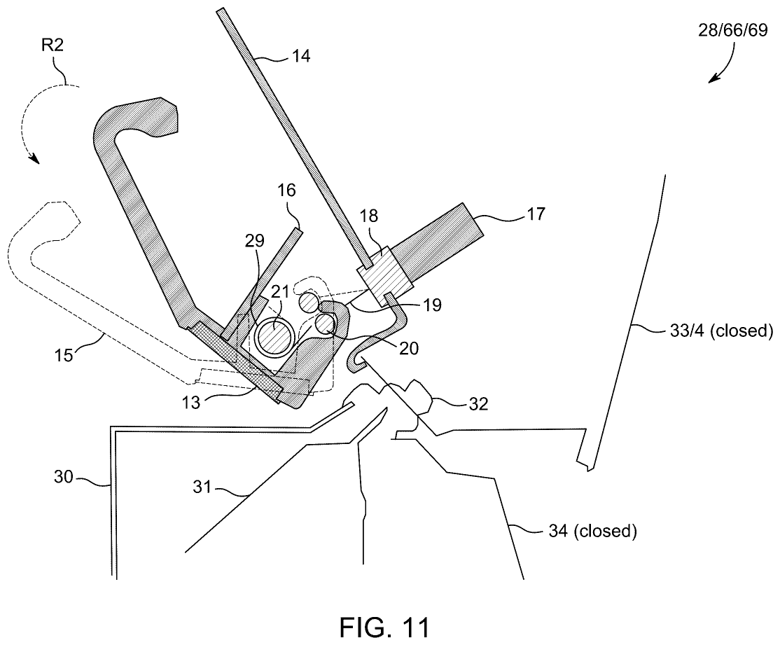

FIG. 2D may show a liftgate trim 12 of trunk or liftgate barrier component 4 that may be configured to be moved for enabling access to any suitable trunk space or trunk compartment component 290ts. Interior panel 11 may include a first multifunction switch interface 69 (e.g., liftgate multifunction switch interface 28) of a multifunction switch system 60 that may be configured to close liftgate barrier component 4 when open (e.g., electronically) and/or used to activate a secondary (e.g., mechanical) opening from the interior cabin (e.g., trunk space or trunk compartment component 290ts) when liftgate barrier component 4 is closed. FIG. 3 provides a detailed view of liftgate trim 12. This panel may be designed with functionality in mind, potentially housing a multifunction switch (e.g., switch 13 of a second multifunction switch interface 69 (e.g., a liftgate multifunction switch interface 28) of a multifunction switch system 60 that may be configured to close liftgate barrier component 4 when open (e.g., electronically) and/or used to be activated as a secondary (e.g., mechanical) opening mechanism from the interior cabin (e.g., trunk space or trunk compartment component 290ts) when liftgate barrier component 4 is closed (e.g., see, e.g., FIG. 11, which may also show any suitable liftgate weather seal 32, any suitable liftgate exterior 33 (e.g., exterior sheet metal, composite, etc.) of liftgate barrier component 4, any suitable rear bumper 34, a trunk sill panel 30, a trunk body 31, and/or the like of a trunk of vehicle 290 of FIG. 2D).

FIG. 2E may provide a detailed view of the interior driver-side front door trim 10 of door 2 of vehicle 290. Trim 10 may include a multifunction switch interface 69 (e.g., a driver-side front door multifunction switch interface 23) of a multifunction switch system 60 that may be configured to open door 2. Switch interface 23 may be strategically positioned on a center armrest of trim 10 of door 2 within easy reach of a user's (e.g., driver's) left hand when seated in seat. A barrier multifunction switch 66 of multifunction switch interface 69 may include an electrical feature, such as a multifunction switch electrical interface component 13, and/or a mechanical feature, such as a multifunction switch mechanical interface component or lever 15, which may be provided via any suitable multifunction switch carrier or housing 14 of multifunction switch interface 69 (e.g., within or otherwise provided by or coupled to trim 10 of door 2 as driver-side front door multifunction switch interface 23).

FIG. 2F shows a multifunction switch and an interconnected modules arrangement of one or more multifunction switch applications or multifunction switch systems 60 of vehicle 290, which may include at least one body control module (“BCM”) 24 and one or more multifunction switch interfaces 69, including, but not limited to, driver-side front door multifunction switch interface 23 (e.g., of trim 10 of door 2), a driver-side rear door multifunction switch interface 22 (e.g., of trim 9 of door 3), a passenger-side front door multifunction switch interface 26 (e.g., of trim 7 of door 5), a passenger-side rear door multifunction switch interface 27 (e.g., of trim 8 of door 6), a hood multifunction switch interface 25 (e.g., of panel 11 and/or hood 1), a liftgate multifunction switch interface 28 (e.g., of panel 11 and/or of trim 12 of liftgate 4), and/or the like, wherein each multifunction switch interface 69 may be coupled (e.g., electrically, communicatively, etc.) to BCM 24. Any multifunction switch interface 69 may be configured to allow a user to operate the activation of a door release system or latch assembly 61 of the multifunction switch interface (e.g., from the interior of vehicle 290 (e.g., within passenger space 290us, within trunk space 290ts, etc.)) by interacting with (e.g., pressing/touching or pulling) a barrier multifunction switch 66 of the multifunction switch interface (e.g., by pressing/touching or otherwise interacting with an electrical feature, such as a multifunction switch electrical interface component 13 of barrier multifunction switch 66, and/or by pulling or otherwise interacting with a mechanical feature, such as a multifunction switch mechanical interface component or lever 15 of barrier multifunction switch 66, which may be provided via any suitable multifunction switch carrier or housing 14 of the multifunction switch interface). Such multifunction switch interface(s) 69 may be integral parts of any multifunction switch system 60 of vehicle 290. Such a multifunction switch system 60 may enable any suitable user of the vehicle to activate a door release mechanism or latch assembly 61 of a multifunction switch interface 69 from inside the vehicle simply by pressing or pulling or touching or otherwise interacting with multifunction switch 66 of the multifunction switch interface(s) 69.

As shown in one or more of FIGS. 2A-18, a multifunction switch system 60 may be configured to control any suitable barrier component (e.g., hood 1, door 2, door 3, liftgate 4, door 5, door 6, etc.) for selectively providing access to any suitable compartment component (e.g., space 290us, space 290ts, etc.) of a vehicle (e.g., vehicle 290), where system 60 may include one or more multifunction switch interfaces 69 (e.g., interface(s) 22, 23, 25, 26, 27, 28, etc.), and any other suitable component(s), including, but not limited to, any suitable body control module (“BCM”) 24, any suitable vehicle control unit (“VCU”) 35, any suitable power distribution module (“PDM”) 36, any suitable airbag control unit (“ACU”) 38, any suitable backup power system (“BPS”) 37, any suitable self-presenting lever actuator (“SPLA”) 45, any suitable self-presenting lever logic control system (“LCS”) 47, any suitable multifunction switch system couplers 58, and/or the like. Each multifunction switch interface 69 may include any suitable component(s), including, but not limited to, any suitable latch assembly 61 (e.g., one or more actuators 57 and/or any suitable component(s) for moving or otherwise actuating a barrier component with respect to a compartment component (e.g., any suitable actuator microcontroller(s) 61c, any suitable electrical latch actuator(s) 61e, any suitable mechanical latch actuator(s) 61m, and/or the like)), any suitable barrier control module 63, any suitable barrier multifunction switch or barrier multifunction switch assembly 66 (e.g., electrical and/or mechanical user interface(s) (e.g., interior/exterior)), any suitable multifunction switch interface coupler(s) 56, and/or the like. Each barrier multifunction switch assembly 66 may include any suitable component(s), including, but not limited to, any suitable multifunction switch electrical interface component 13 (e.g., an electrical switch user interface feature), any suitable multifunction switch mechanical interface component or lever 15 (e.g., a mechanical feature or mechanical lever user interface feature), any suitable multifunction switch carrier or housing 14 (e.g., within or otherwise provided by or coupled to any suitable vehicle feature (e.g., trim 7, 8, 9, 10, 11, 12, etc.), any suitable multifunction switch harness 16, any suitable latch mechanical release cable cover 17, any suitable latch mechanical release cable grommet 18, any suitable latch mechanical release cable 19, any suitable latch mechanical release cable stop 20, any suitable multifunction switch lever pin 21, any suitable rotary spring 29, any suitable cylinder rod 50, any suitable connecting link 51, any suitable link rod 52, any suitable illuminator element 53 (e.g., an LED, lightbulb, etc.), and/or the like. Multifunction switch interface coupler(s) 56 may include any suitable coupler(s), including, but not limited to, any suitable two-way communication and/or power interface coupler(s) 62 (e.g., extending between latch assembly 61 and barrier control module 63), any suitable two-way communication and/or power interface coupler(s) 65 (e.g., extending between barrier control module 63 and barrier multifunction switch 66), any suitable power interface coupler(s) 40 (e.g., extending from barrier multifunction switch 66 to latch assembly 61), any suitable latch mechanical release cable assembly (ies) 67 (e.g., extending between barrier multifunction switch 66 and latch assembly 61), and/or the like. Multifunction switch system couplers 58 may include any suitable coupler(s), including, but not limited to, any suitable two-way communication coupler(s) 39 (e.g., extending between PDM 36 and BPS 37), any suitable power interface coupler(s) 41 (e.g., extending from BPS 37 to barrier multifunction switch 66), any suitable power interface coupler(s) 42 (e.g., extending from PDM 36 to one or multiple modules (e.g., latch assembly 61, barrier control module 63, BCM 24, VCU 35, and/or the like)), any suitable two-way communication coupler(s) 43 (e.g., extending between VCU 35 and ACU 38), any suitable interface linkage coupler(s) 44 (e.g., extending between SPLA 45 and barrier multifunction switch 66), any suitable two-way communication coupler(s) 46 (e.g., extending between SPLA 45 and LCS 47), any suitable two-way communication coupler(s) 48 (e.g., extending between ACU 38 and LCS 47), any suitable two-way communication coupler(s) 49 (e.g., extending between ACU 38 and BPS 37), any suitable power interface coupler(s) 54 (e.g., extending from PDM 36 to SPLA 45), any suitable two-way communication and/or power interface coupler(s) 64 (e.g., extending between barrier control module 63 and BCM 24), any suitable two-way communication and/or power interface coupler(s) 68 (e.g., extending between BCM 24 and VCU 35), and/or the like.

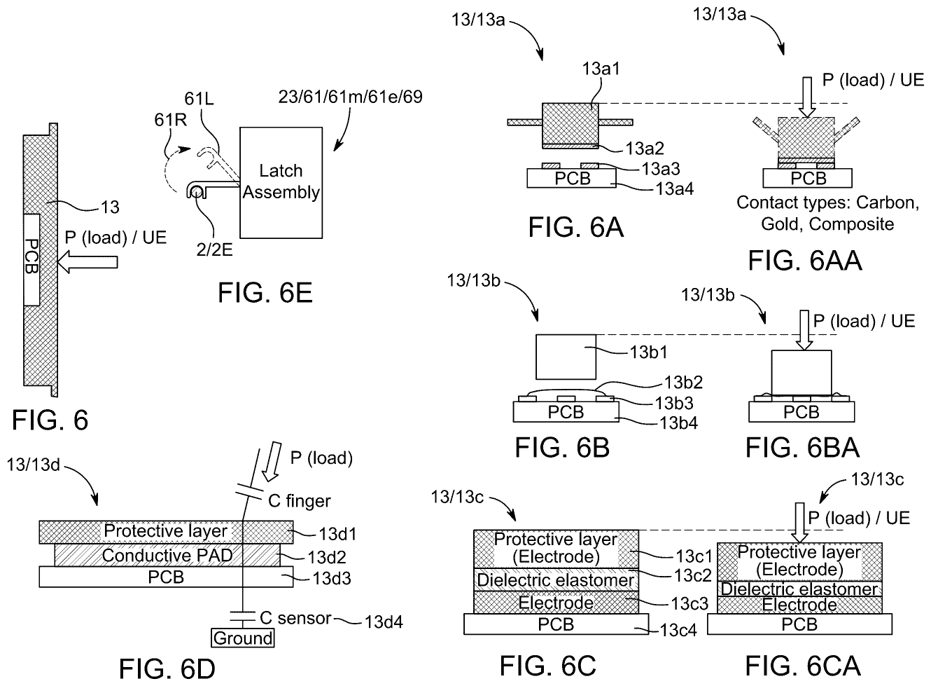

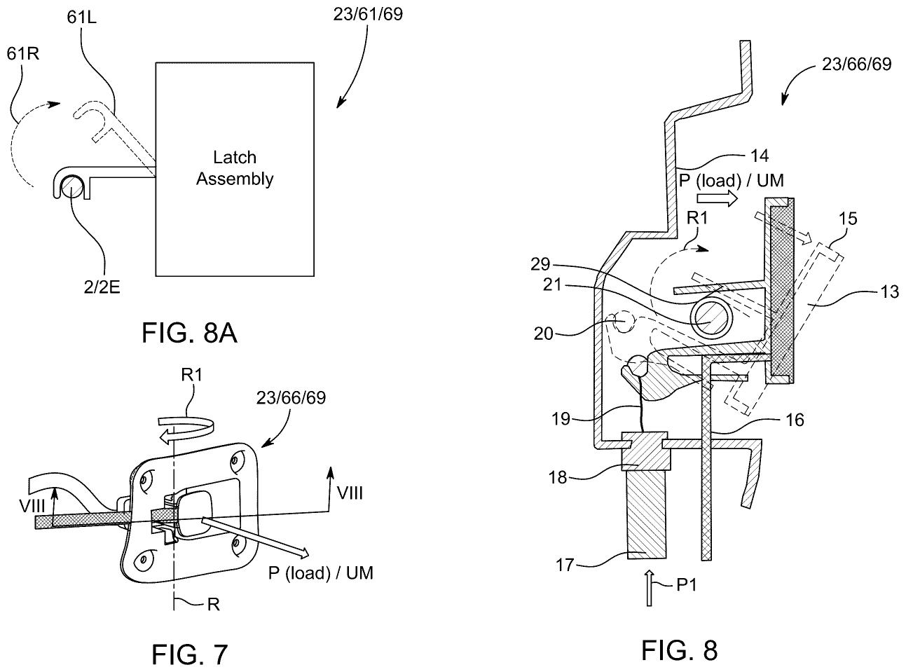

FIGS. 3-5 may provide a detailed view of a multifunction switch interface 69 (e.g., driver-side front door multifunction switch interface 23) and its associated components. These may include electrical interface feature 13, carrier/housing 14, mechanical interface feature or lever 15, and harness 16. FIGS. 3-5 may also show the construction of at least a portion of a latch mechanical release system (e.g., latch mechanical release cable assembly 67), which may include cable cover 17, cable grommet 18, release cable 19, cable stop 20, and lever pin 21 (e.g., as described with respect to FIGS. 7, 8, and 8A). A procedure to activate the primary, electronic door opening release may also be depicted. This may involve applying a load (e.g., P (load) (e.g., an electrical load (e.g., using a user's touch of a user electrical load UE (e.g., a tap, press, swipe, etc.)))) to an exposed surface of electrical interface feature 13. This action may generate a signal that may be sent via electrical interface feature 13 and then via an electrically conductive harness 16 (e.g., as coupler 65) to barrier control module 63, which may be configured to trigger latch assembly 61 (e.g., using any suitable signal via coupler 62) to open a barrier component that may be functionally coupled to latch assembly 61 (e.g., to move at least a portion of a barrier component away from a barrier opening of a compartment component). For example, as shown in FIG. 6E and/or FIG. 8A, any suitable electrical latch actuator 61e and/or any suitable mechanical latch actuator 61m of latch assembly 61 may be configured to actuate a latch 61L (e.g., in response to any suitable electrical signal (e.g., via coupler 62) and/or in response to any suitable mechanical force (e.g., via latch mechanical release cable assembly 67)) to move latch 61L in any suitable direction (e.g., in the direction of arrow 61R) from a closed position to an open position to unlatch latch 61L from any suitable portion of any suitable barrier component (e.g., feature 2E of barrier component 2) for opening that barrier component with respect to an associated compartment component or for otherwise moving at least a portion of a barrier component away from a barrier opening of a compartment component (e.g., for opening door 2 with respect to a door opening portion of passenger space 290us (e.g., a door opening body portion 2BDO of a body of vehicle 290 that may define an opening 2DO in which door 2 may be selectively positioned for providing or terminating access to space 290us via opening 2DO)). This latch assembly actuation may be configured to enable movement of the barrier component with respect to the compartment component in any suitable way. For example, the latch assembly may be configured to unlock the barrier component such that the barrier component may then be opened by a user (e.g., pushed/pulled) with respect to a compartment component opening or the latch assembly may be configured to actually open the barrier component (e.g., latch 61L or otherwise of latch assembly 61 may be configured to push the barrier component away from the compartment component).

FIGS. 6 and 6A-6D provide views of various electrical switch constructions of multifunction switch electrical interface component 13. They may highlight specific designs, but it is important to note that these are not the only possibilities; the construction can also accommodate other designs. FIGS. 6 and 6A-6D illustrate scenarios where a load, denoted as P (load), may be applied as an electrical user load. This load may be crucial in activating the signal generated in a printed circuit board (“PCB”). One of the key features of the construction may be the use of an elastomeric or flexible keypad assembly 13a for multifunction switch electrical interface component 13, as shown in FIGS. 6A and 6AA. This assembly may include any suitable aesthetic pad or surface 13a1 and any suitable conductive layer 13a2. Conductive layer 13a2 may interact with any suitable terminals 13a3 that may be incorporated into any suitable PCB 13a4. When a load P is applied to keypad 13a1, conductive layer 13a2 may establish contact with both terminals 13a3. This action may initiate a signal that may be transmitted to any suitable barrier control module 63 (e.g., via coupler 65), thereby activating the switch for controlling any suitable latch assembly 61 electronically (e.g., via any suitable signal(s) along coupler 62). The construction may also or alternatively include other types, such as a metal dome 13b, as shown in FIGS. 6B and 6BA, which may be similar to the elastomeric keypad but may replace conductive layer 13a2 with any suitable conductive metal dome 13b3 for interacting with any suitable terminals 13b3 that may be incorporated into any suitable PCB 13b4. A capacitive force sensor 13c, as shown in FIGS. 6C and 6BC, may replace contact terminals 13a3/13b3 with any suitable dielectric elastomer 13c2 and an electrode 13c3. Application of load P on any suitable protective layer (e.g., electrode) 13c1 may generate pressure in dielectric elastomer 13c2, which may trigger electrode 13c3 to send a signal to any suitable PCB 13c4. Another variant may be a capacitive sensor 13d of FIG. 6D, where any suitable conductive PAD 13d2 may transmit a discharge through any suitable PCB 13d3 and any suitable capacitive sensor 13d4 when a user's finger comes into contact with protective layer 13d1. In some embodiments, the terminals/electrodes may be electrically coupled to a remote PCB via one or more wires or any other suitable coupler(s). Minimum electronics may be used, as there may be two laminated conductive terminals, and a signal may be transferred to a remote PCB for post-processing the signal.

As shown in FIGS. 3-5, 7, 8, and 8A, switch interface 69 may include switch 66 with electrical interface feature 13, carrier/housing 14, mechanical interface feature or lever 15, and harness 16, as well as latch assembly 61. The construction of at least a portion of a latch mechanical release system (e.g., latch mechanical release cable assembly 67) may also be shown, which may include cable cover 17, cable grommet 18, release cable 19, cable stop 20, and lever pin 21. Multifunction switch-associated components may be shown for illustrating the activation of a secondary release system (e.g., a mechanically released mechanism). As shown, carrier/housing 14 may be designed to provide ample finger clearance to a backside of multifunction switch electrical interface component 13, which may be supported by any suitable multifunction switch mechanical interface component or lever 15. This may allow a user to pull (e.g., with one or more curled fingers) lever 15 from the back (e.g., for rotating lever 15 about a rotation axis R of (e.g., a longitudinal axis of) lever pin 21 in a first direction R1 that may be biased against a rotary spring 29 configured to bias lever 15 back about axis R in a direction opposite direction RI when the user mechanical load UM (e.g., pulling force P (load)) is released from lever 15). Pin 21 may be coupled to (e.g., fixed to) housing 14 or any other suitable portion of vehicle 290 (e.g., trim 10, door 2, door opening body portion 2BDO of a body of vehicle 290, etc.). A portion of lever 15 may interact with lever 15 and/or spring 29 to enable rotation of lever 15 about axis R, while another portion of lever 15 may be coupled to cable stop 20 and/or an end of cable 19 and may pull cable 19 in direction PI due to the user mechanical load UM rotating lever 15 in direction R1, where cable 19 may be coupled at one end to stop 20 and/or lever 15 and at another end to latch assembly 61 (e.g., any suitable mechanical latch actuator(s) 61m), which may activate the secondary mechanical operation for activating an associated barrier component motion with respect to a compartment component when cable 19 pulls at latch assembly 61 (e.g., as shown in FIG. 6E and/or FIG. 8A). Therefore, cable 19 may extend (e.g., as latch mechanical release cable assembly 67) all the way from switch 66 (e.g., cable stop 20 at lever 15) to latch assembly 61 to release the latch assembly for opening a barrier component with respect to a compartment component.

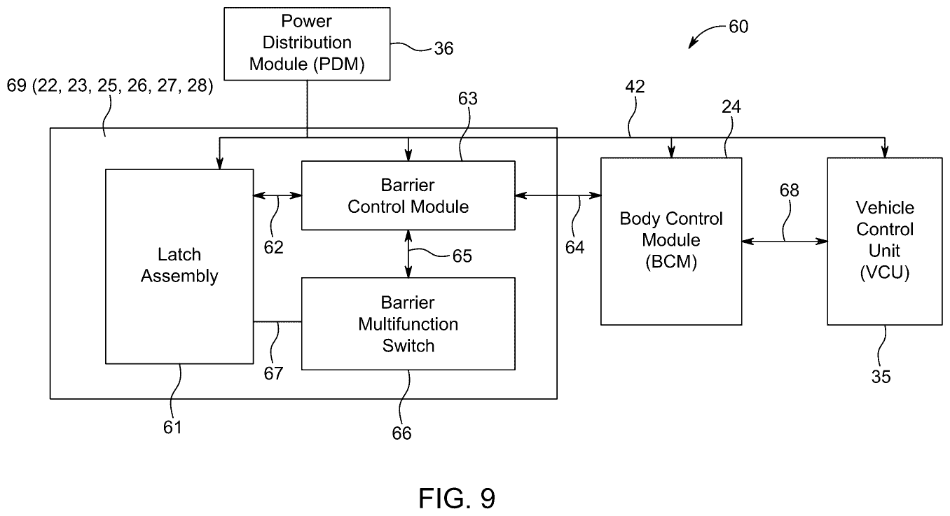

FIG. 9 illustrates exemplary intricate details of any suitable multifunction switch interface 69, which may include interconnected modules, a fundamental communication network, and a mechanical actuator. Multifunction switch interface 69 may be applied in various contexts, such as door rear driver-side multifunction switch interface 22, door front driver-side multifunction switch interface 23, hood multifunction switch interface 25, door front passenger-side multifunction switch interface 26, door rear passenger-side multifunction switch interface 27, and/or liftgate multifunction switch interface 28. Multifunction switch interface 69 may include latch assembly 61, a two-way communication and power interface coupler 62 from latch assembly 61 to a barrier control module 63, a two-way communication and power interface coupler 64 from barrier control module 63 to body control module 24, a two-way communication and power interface coupler 65 (e.g., a two way bus interface) from barrier control module 63 to barrier multifunction switch 66, a latch mechanical release cable assembly 67 (e.g., cable(s) 19), and a two-way communication and power interface 68 from body control module 24 to any suitable vehicle control unit 35, which may be a higher level up control module. Each one of switch interfaces 69 of vehicle 290 (e.g., interfaces 22, 23, 25, 26, 27, and/or 28) may be intercoupled through the BCM 24, which may serve as a primary control interface, and which may be configured to manage communication with any suitable main control unit, such as VCU 35.

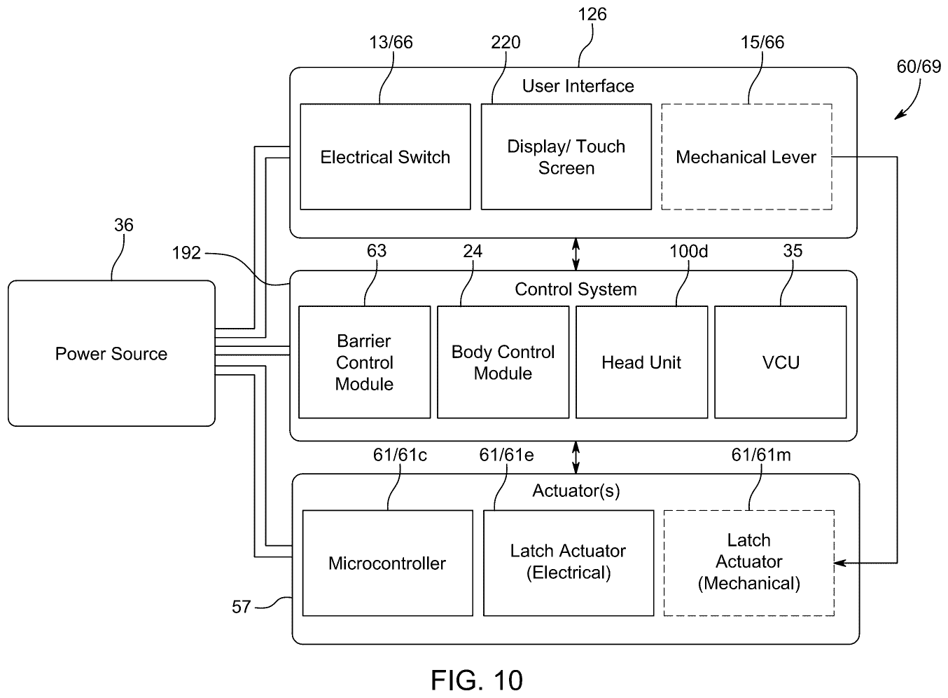

FIG. 10 may present at least portions of a multifunction switch interface 69 of a multifunction switch system 60 as a block diagram, such as a comprehensive system that may facilitate logical communication between various components. These components may include, but are not limited to, a user interface component, such as an I/O component 126 (e.g., a primary point of interaction for a user, which may include elements like the multifunction switch 66 (electrical switch 13 and/or mechanical lever 15) and/or a display/touch screen (e.g., of a subsystem 220), which may allow the user to input commands), a control system component, such as a subsystem 192 (e.g., a system that may process a user's inputs from user interface 126 and translate them into actionable commands, and may include barrier control module 63, any suitable head unit (e.g., subsystem 100d), VCU 35, and/or BCM 24, where these components may work together to ensure seamless operation), and/or actuator(s) component 57 (e.g., components that may perform any suitable physical actions based on the commands from control system 192, and may include electrical latch actuator(s) 61e and/or mechanical latch actuator(s) 61m and/or microcontroller(s) 61c of any suitable latch assembly (ies) 61, which may be configured to execute the opening and/or closing of any suitable barrier component(s) with respect to associated compartment component(s)). Mechanical lever 15 of switch 66 may be another crucial element (e.g., of User Interface 126) that may provide a manual override option for a user. The system's power-driven design may ensure efficient and effective communication between user interface 126, control system 192, and actuator(s) 57, thereby resulting in a smooth and responsive user experience.

FIGS. 2D and 11 show switch 66 of multifunction switch interface 69 for providing liftgate multifunction switch interface 28. As shown, for a liftgate, a user may activate switch 66 by either pressing multifunction switch electrical interface component 13 electronically (e.g., when the user is outside the vehicle and the liftgate is opened or when the user in inside the vehicle and the liftgate is closed) or pulling (e.g., in direction R2 about a rotation axis or otherwise) multifunction switch mechanical interface component or lever 15 mechanically (e.g., when the user is inside the vehicle and the liftgate is closed, as an auxiliary/emergency latch actuator when unpowered). On the other hand, primary liftgate switches may be the ones in the exterior of the liftgate door garnish and/or decorative bezel, which may be the one included in the multifunction switch; and the one in instrument panel 11, door trim 10 in the form of hardware switch or software one may be included in a center information display (e.g., of subsystem 220f). The diagram illustrates the application of a liftgate multifunction switch, similar to those used in doors or hoods. This system may include several key components that may be essential for its effective operation: a multifunction switch lever 15, a multifunction electrical switch 13, multifunction switch harness 16, latch mechanical release cable 17, latch mechanical release cable stop 20, latch mechanical release cable cover 17, latch mechanical release cable grommet 18, multifunction switch carrier/housing 14, rotary spring 29, multifunction switch lever pin 21, trunk sill panel 30, body 31 (e.g., body in white), liftgate weather seal 32, liftgate (e.g., exterior sheet metal/composite) 33 of liftgate 4, and/or a rear bumper 34.

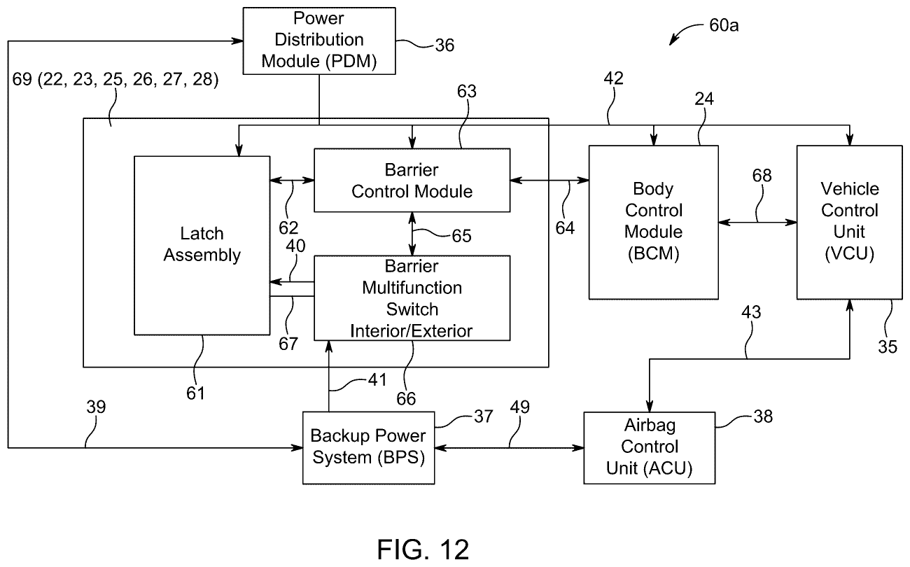

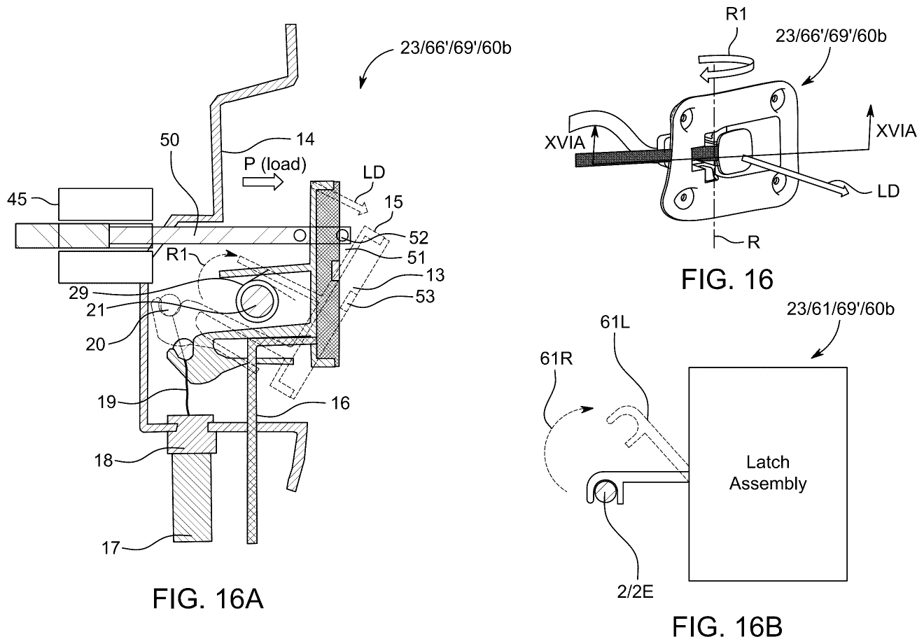

FIG. 12 illustrates exemplary intricate details of any suitable multifunction switch interface 69 of any suitable multifunction switch system 60a, which may be similar to system 60 of FIG. 9 but may include backup power system (“BPS”) 37 and ACU 38, along with couplers 39, 49, 43, and 40, which may allow multifunction switch interface 69 to remain operative when a full or partial primary power source (e.g., PDM 36) and its electric module controls are not present or operating. BPS 37 may be configured to function by continuously monitoring the main PDM 36 through two-way bus interface coupler 39. When no power is detected from PDM 36, BPS 37 may be configured to override the power supply function and enable barrier multifunction switch 66 (e.g., using independent power distribution couplers 41/40 between BPS 37, switch 66, and latch assembly 61 (e.g., not via barrier control module 63 and/or coupler(s) 42 from PDM 36). Additionally or alternatively, in the case of a partial function of PDM 36 and the system's control modules (e.g., modules 63, 24, and/or 35), BPS 37 may be configured to continuously monitor ACU 38 with two-way bus interface coupler(s) 49. In a scenario where airbags are activated and modules are partially operating, BPS 37 may still be configured to override PDM 36 and preserve the power to switch 66 to activate latch assembly 61. A dedicated awareness illumination element 53 (e.g., at switch 13 (see, e.g., FIG. 16A)) may be activated under the same circumstances while BPS 37 is triggered.

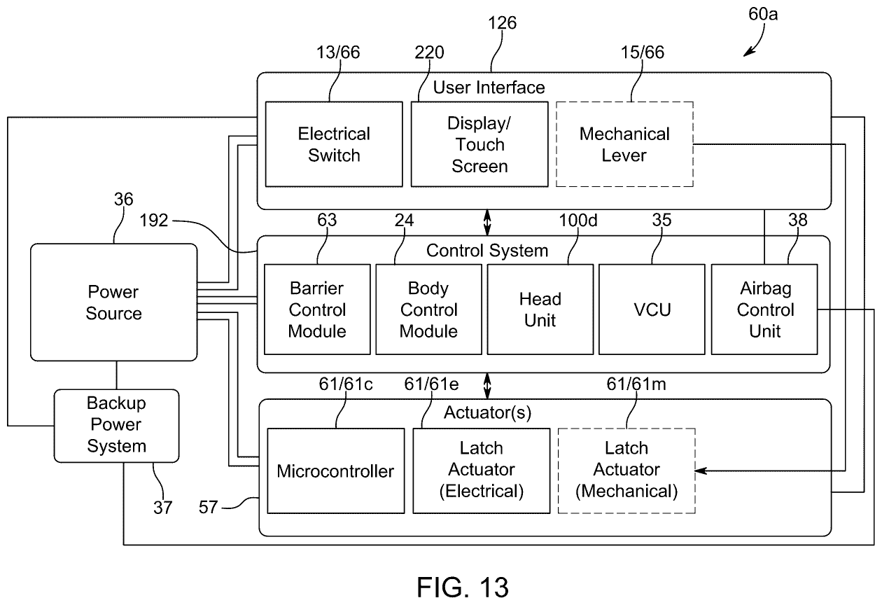

FIG. 13 may be similar to FIG. 10 but for system 60a rather than system 60. As shown, the block diagram may present a multifunction switch interface block diagram with BPS 37, which may provide a comprehensive system that facilitates logical communication between various components. Such components may include user interface component 126 (e.g., a primary point of interaction for the user, which may include elements like switch 66 and subsystem screen 220, which may allow the user to input commands (e.g., for mechanical lever 15 (no powered) interface, there may be a physical mechanical connection (e.g., a pulling cable 19) to latch actuator 61 that may be mechanically operated), control system component 192 (e.g., a system that may process the user's inputs and translate them into actionable commands, and may include barrier control module 63, BCM 24, head unit 100d, VCU 35, and ACU 38, where, for ACU 38, there may be a dedicated two-way bus interface coupler to BPS 37, where these components work together to ensure seamless operation), actuator(s) component 57 (e.g., components that may be configured to perform physical actions based on the commands from the control system, which may include the electrical and mechanical latch actuators of latch assembly 61, which may execute the opening and closing of doors, liftgates, and hoods), a power source 36 (e.g., a primary power supply source that may be configured to power the system's electrical components), and BPS 37 (e.g., a secondary power supply source that may be configured to provide power to dedicated components in the user interface and actuator components, which may ensure the preservation and maintenance of its primary function within the system when the power source or control system may not be fully operating).

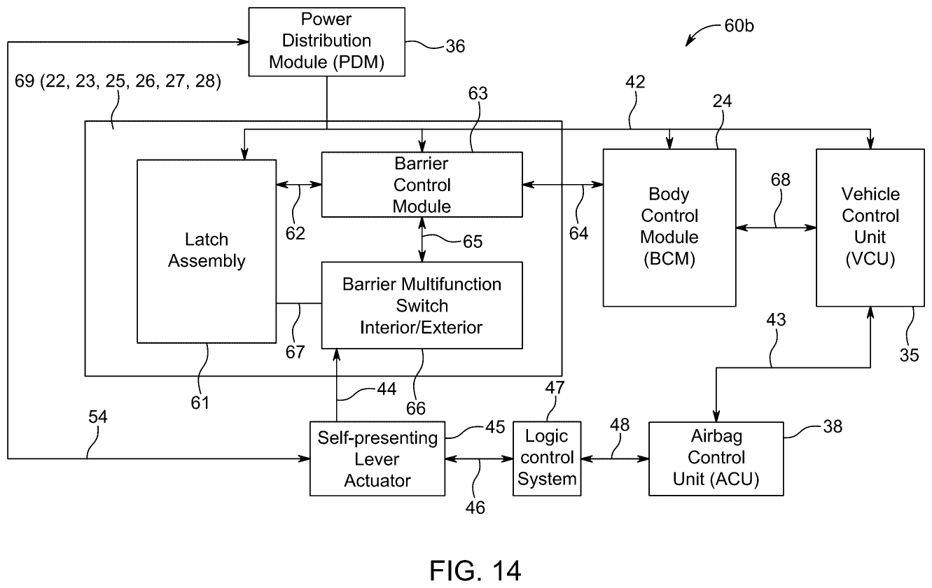

FIG. 14 illustrates exemplary intricate details of any suitable multifunction switch interface 69 of any suitable multifunction switch system 60b, which may be similar to system 60 of FIG. 9 but may include self-presenting lever elements, which may allow multifunction switch interface 69 to be exposed and/or self-presented to a user when the full or partial primary power source (e.g., PDM 36) and the electric module controls (e.g., modules 63, 24, 35, and/or 38) are not present or operating. This may be designed to alert a user to a physical, mechanical, non-electrical release system that can be activated by continuously pulling lever 15 of switch 66. System 60b may include self-presenting lever actuator 45 that may be constantly powered by PDM 36 through power interface coupler 54. While powered, actuator 45 may be configured to activate a solenoid system that may be configured to retract a cylinder rod 50 coupled to switch lever 15 through a connection link 51 and rod 52 (e.g., as shown in FIGS. 16, 16A, and 16B, where a switch 66′ of an interface 69′ of system 60b may include actuator 45, which may include solenoid, cylinder rod 50, connecting link 51, link rod 52, and an internal spring (not shown), while a dedicated awareness illumination element 53 may be activated under the same circumstances when either lever actuator 45 or BPS 37 are triggered). When no power is detected from PDM 36, lever actuator 45 may be configured to de-energize the solenoid, thereby allowing cylinder rod 50 to expand (e.g., due to an internal spring in self-presenting lever actuator 45). This action may present the switch lever 15 through connection link 51 and rod 52 to cylinder rod 50 (e.g., in a lever self-presented direction LD). Additionally, in the case of a partial function of PDM 36 and the control modules (e.g., modules 63, 24, and/or 35), lever actuator 45 may be continuously monitored by logic control system 47 with a two-way bus interface 46 to ACU 38 via two-way bus interface 48. In a scenario where airbags may be activated and modules may be partially operating, logic control system 47 may be configured to still override PDM 36 and activate lever actuator 45 by de-energizing it. A dedicated awareness illumination element 53 may be activated under the same circumstances while lever actuator 45 is triggered. Therefore, SPLA 45 may be configured to have mechanical lever 15 pop out when needed. SPLA 45 may be powered by PDM 36 so all switches are always in composition. LCS 47 and couplers 46/48, in case of a crash, may enable ACU 38 to override PDM 36 (e.g., if lack of power on PDM 36) to enable safe operation of ACU 38.

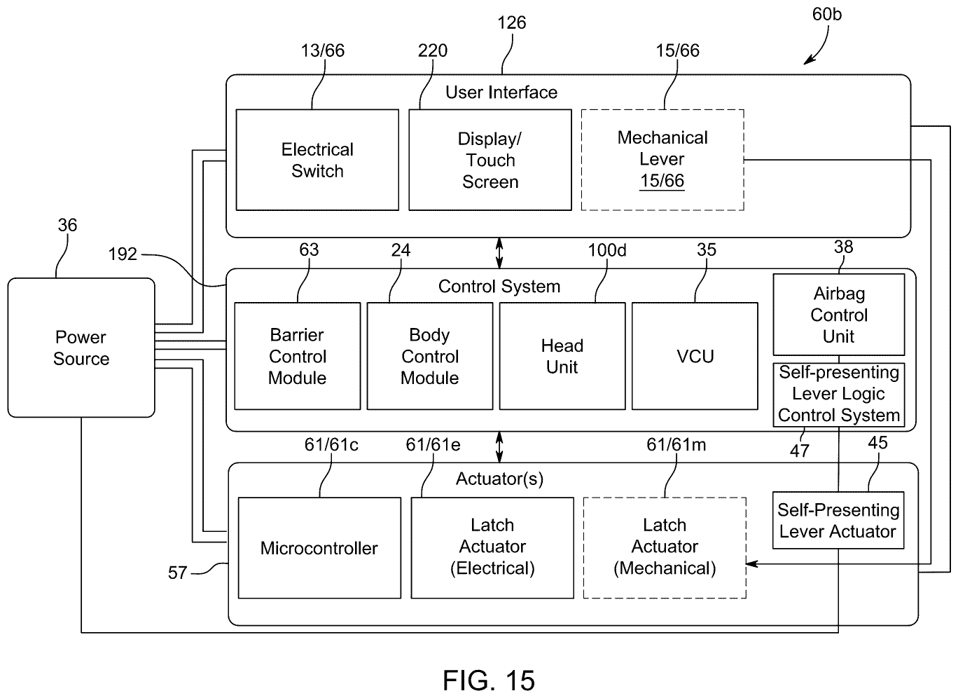

FIG. 15 may be similar to FIG. 10 but for system 60b rather than system 60. As shown, the block diagram may present a multifunction switch interface block diagram with SPLA 45, a comprehensive system that may be configured to facilitate logical communication between various components, which may include user interface component 126 (e.g., a primary point of interaction for a user, which may include elements like multifunction switch 66 and any suitable display/touch screen 220, which may allow a user to input commands, and, for the mechanical lever 15, there may be a physical mechanical connection, a pulling cable 19, to mechanically operate latch actuator 61), control system component(s) 192 (e.g., where the system may processes the user's inputs and translate them into actionable commands, which may include barrier control module 63, BCM 24, head unit 100d, VCU 35, ACU 38, and LCS 47, and, where, for ACU 38, there may be a dedicated two-way bus interface to LCS 47, which, with an additional two-way bus interface, may be configured to communicate to SPLA 45, whereby these components may work together to ensure seamless operation), actuator(s) component 57 (e.g., components that may be configured to perform physical actions based on the commands from control system 192, which may include the electrical and mechanical latch actuators of latch assembly 61 and SPLA 45, which may execute the opening and closing of doors, liftgates, and hoods), and power source 36 (e.g., a primary power supply source that may be configured to power the system's electrical components, where there may be a dedicated power interface to SPLA 45 to energize it while the system is on).

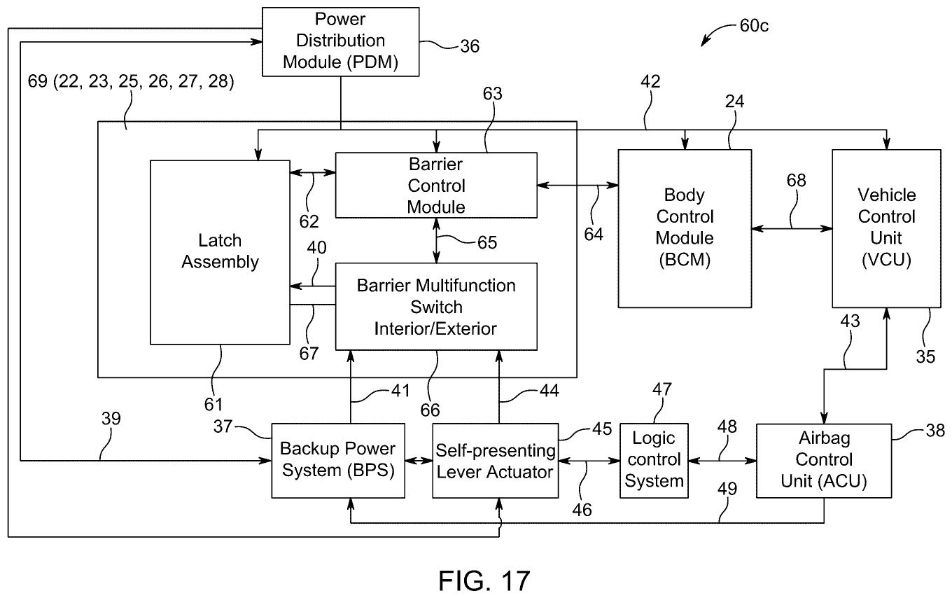

FIG. 17 illustrates exemplary intricate details of any suitable multifunction switch interface 69 of any suitable multifunction switch system 60c, which may be similar to system 60a of FIG. 12 but with the additional components of system 60b of FIG. 14, thereby providing an integration of both SPLA 45 and BPS 37 into the multifunction switch interface. This integration may include an independent power distribution and two-way bus interfaces. The purpose of this combination may be to enhance the functionality by leveraging the features described in FIGS. 12 and 14.

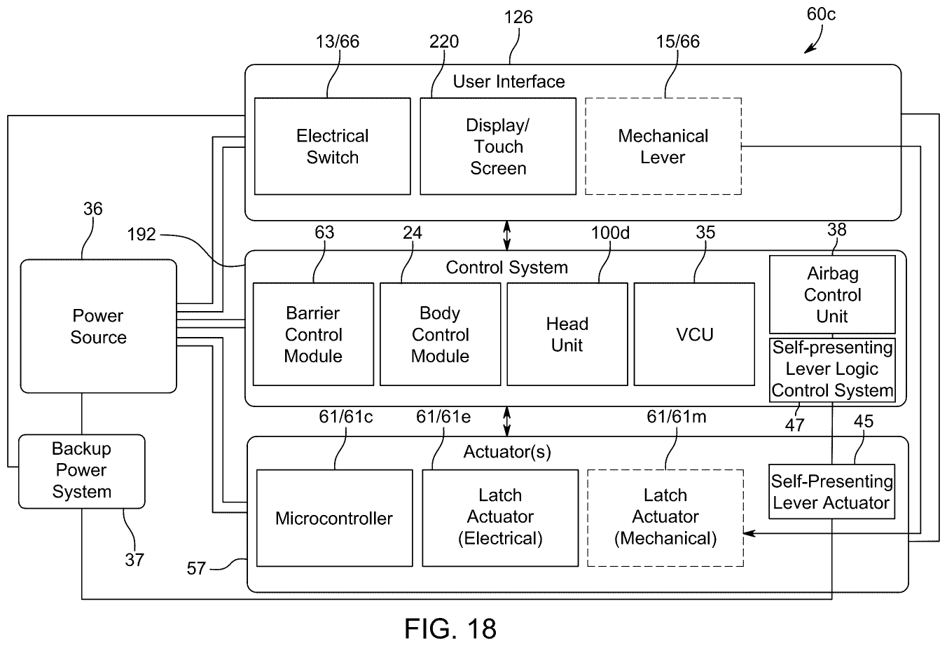

FIG. 18 may be similar to FIG. 10 but for system 60c rather than system 60. As shown, the block diagram may present a multifunction switch interface block diagram with the integration of both SPLA 45 and BPS 37 into the multifunction switch interface for a comprehensive system that may be configured to facilitate logical communication between various components (e.g., user interface component 126, control system component 192, actuator(s) component 57, and BPS 37). This integration may include an independent power distribution and two-way bus interfaces. The purpose of this combination may be to enhance the functionality by leveraging the features described in FIGS. 13 and 15. The block diagram may present the multifunction switch interface block diagram with a self-presenting lever, and a comprehensive system that may be configured to facilitate logical communication between various components.

Other embodiments may include a multifunction switch that can be mounted on different surfaces of an Instrument Panel, Center Console, Door trim, Overhead Console, Trunk, Front storage compartment, and/or the like. The vehicle may be configured such that voice-activated commands may be utilized to also open door, liftgate, hood, and/or the like. A control system may be designed to provide a backup power source and a self-presenting lever.

Although described with respect to opening doors of a vehicle, a multifunction switch of the disclosure may be configured to be used in any suitable system for activating any suitable object reconfiguration mechanically or electronically (e.g., opening a door to a smart home, etc.).

In some embodiments, there is provided a vehicle (e.g., vehicle 290) that may include a barrier component (e.g., door 2), a compartment component defining a barrier opening (e.g., door opening body portion 2BDO of body of vehicle 290 that may define opening 2DO in which door 2 may be selectively positioned for providing or terminating access to space 290us via opening 2DO), and a multifunction switch system (e.g., system 260) that may include a barrier multifunction switch (e.g., switch 66) that may include a mechanical interface component (e.g., lever 15) that may be configured to be moved from a first mechanical switch position to a second mechanical switch position, and an electrical interface component (e.g., interface component 13) coupled to the mechanical interface component, and a latch assembly (e.g., latch assembly 61) that may be configured to enable movement of at least a portion of the barrier component away from the barrier opening in response to movement of the mechanical interface component from the first mechanical switch position to the second mechanical switch position, and enable movement of at least the portion of the barrier component away from the barrier opening in response to an interface electrical signal being generated by the electrical interface component. In some embodiments, the mechanical interface component may be accessible to receive a user mechanical load (e.g., load UM) to move the mechanical interface component from the first mechanical switch position to the second mechanical switch position, and the electrical interface component may be accessible to receive a user electrical load (e.g., load UE) to generate the interface electrical signal. In some embodiments, the electrical interface component may be coupled to a front surface of the mechanical interface component, and a rear surface of the mechanical interface component may be accessible to receive a user mechanical load (e.g., load UM) to move the mechanical interface component from the first mechanical switch position to the second mechanical switch position, and where, in some embodiments, the electrical interface component is accessible to receive a user electrical load (e.g., load UE) to generate the interface electrical signal. In some embodiments, the multifunction switch system may also include a lever pin (e.g., pin 21) and a cable (e.g., cable 19) extending between a first end coupled to the mechanical interface component and a second end coupled to the latch assembly, and the mechanical interface component may be configured to be rotated about the lever pin from the first mechanical switch position to the second mechanical switch position for pulling the first end of the cable in a cable direction (e.g., direction P1), and where, in some embodiments, the lever pin may be coupled to the barrier component and/or where, in some embodiments, the multifunction switch system may also include a rotary spring (e.g., spring 29) that may be configured to rotate the mechanical interface component about the lever pin from the second mechanical switch position to the first mechanical switch position and/or where, in some embodiments, the multifunction switch system may also include a rod (e.g., rod 50/52) and a lever actuator (e.g., actuator 45) that may be configured to extend an end of the rod away from the lever actuator to rotate the mechanical interface component about the lever pin from the first mechanical switch position towards the second mechanical switch position and/or where, in some embodiments, the lever actuator may be configured to extend the end of the rod towards the lever actuator when a power supply (e.g., source 36) to the lever actuator is terminated and/or where, in some embodiments, the multifunction switch system may also include an illumination element (e.g., element 53) and the lever actuator may be configured to illuminate the illumination element when the power supply to the lever actuator is terminated, where the electrical interface component may include the illumination element. In some embodiments, the vehicle may also include a power supply (e.g., source 36) that may be configured to provide power to the multifunction switch system. In some embodiments, the vehicle may also include a backup power system (e.g., BPS 37) that may be configured to determine when no power is provided by the power supply and then provide power from the backup power system to the barrier multifunction switch. In some embodiments, the latch assembly may be configured to enable movement of at least a portion of the barrier component away from the barrier opening by releasing the portion of the barrier component from a latch (e.g., latch 61L) of the latch assembly. In some embodiments, the latch assembly may be configured to enable movement of at least a portion of the barrier component away from the barrier opening by moving the portion of the barrier component away from the latch assembly. In some embodiments, the vehicle may be one of the following: a road vehicle; a rail vehicle; a watercraft; or an aircraft. In some embodiments, the barrier component may be one of the following: a passenger door barrier component to a passenger compartment component; a liftgate barrier component to a trunk compartment component; a hood barrier component to an engine compartment component; a charging cap barrier component to a charging compartment component; a fuel barrier component to a fuel compartment component; a glove box barrier component to a glove box compartment component; or a console barrier component to a console compartment component. In some embodiments, the barrier multifunction switch may be coupled to the barrier component.

In some embodiments, there is provided a vehicle (e.g., vehicle 290) that may include a barrier component (e.g., door 2), a compartment component defining a barrier opening (e.g., door opening body portion 2BDO of body of vehicle 290 that may define opening 2DO in which door 2 may be selectively positioned for providing or terminating access to space 290us via opening 2DO), and a multifunction switch system (e.g., system 260) that may include a barrier multifunction switch (e.g., switch 66) that may include a mechanical interface component (e.g., lever 15) that may be configured to be moved from a first mechanical switch position to a second mechanical switch position, and an electrical interface component (e.g., interface component 13) coupled to a surface of the mechanical interface component, and a latch assembly (e.g., latch assembly 61) that may be configured to enable movement of at least a portion of the barrier component away from the compartment component in response to an interface electrical signal being generated by the electrical interface component.

In some embodiments, there is provided a vehicle (e.g., vehicle 290) that may include a barrier component (e.g., door 2), a compartment component defining a barrier opening (e.g., door opening body portion 2BDO of body of vehicle 290 that may define opening 2DO in which door 2 may be selectively positioned for providing or terminating access to space 290us via opening 2DO), and a multifunction switch system (e.g., system 260) that may include a barrier multifunction switch (e.g., switch 66) and a latch assembly (e.g., latch assembly 61) that may be operable to move the barrier component away from the compartment component in response to mechanical movement of the barrier multifunction switch and move the barrier component away from the compartment component in response to an interface electrical signal generated by the barrier multifunction switch.

One, some, or all of the processes described with respect to FIGS. 1-18 and otherwise may each be partially or entirely implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and a data storage device (e.g., memory 123 of FIG. 1A). In other embodiments, the computer-readable medium may be a transitory computer-readable medium. In such embodiments, the transitory computer-readable medium can be distributed over network-coupled computer systems so that the computer-readable code is stored and executed in a distributed fashion. For example, such a transitory computer-readable medium may be communicated from one subsystem to another directly or via any suitable network or bus or the like. Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

Any, each, or at least one module or component or subsystem of the disclosure may be provided as a software construct, firmware construct, one or more hardware components, or a combination thereof. For example, any, each, or at least one module or component or subsystem of any suitable system may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. The number, configuration, functionality, and interconnection of the modules and components and subsystems of system 101 are only illustrative, and that the number, configuration, functionality, and interconnection of existing modules, components, and/or subsystems may be modified or omitted, additional modules, components, and/or subsystems may be added, and the interconnection of certain modules, components, and/or subsystems may be altered.

Implementations within the scope of the present disclosure can be partially or entirely realized using a tangible computer-readable storage medium, or multiple tangible computer-readable storage media of one or more types, encoding one or more instructions. The tangible computer-readable storage medium also can be non-transitory in nature.

At least a portion of one or more of the modules of system 101 may be stored in or otherwise accessible to a subsystem (e.g., subsystem 120) in any suitable manner (e.g., in memory 123). Any or each module of system 101 may be implemented using any suitable technologies (e.g., as one or more integrated circuit devices), and different modules may or may not be identical in structure, capabilities, and operation. Any or all of the modules or other components of system 101 may be mounted on an expansion card, mounted directly on a system motherboard, or integrated into a system chipset component (e.g., into a “north bridge” chip).

Any or each module of system 101 may be a dedicated system implemented using one or more expansion cards adapted for various bus standards. For example, all of the modules may be mounted on different interconnected expansion cards or all of the modules may be mounted on one expansion card. With respect to system 101, by way of example only, modules of system 101 may interface with a motherboard or processor assembly 122 (e.g., of subsystem 120) through an expansion slot (e.g., a peripheral component interconnect (“PCI”) slot or a PCI express slot). Alternatively, modules of system 1 need not be removable but may include one or more dedicated modules that may include memory (e.g., RAM) dedicated to the utilization of the module. In other embodiments, modules of system 101 may be at least partially integrated into a subsystem (e.g., subsystem 120 (e.g., a server)). For example, a module of system 101 may utilize a portion of memory 123 of a subsystem. Any or each module of system 101 may include its own processing circuitry and/or memory. Alternatively, any or each module of system 101 may share processing circuitry and/or memory with any other module of system 101 and/or processor assembly 122 and/or memory assembly 123 of a subsystem (e.g., subsystem 120).

The computer-readable storage medium can be any storage medium that can be read, written, or otherwise accessed by a general purpose or special purpose computing device. including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM The computer-readable medium also can include any non-volatile semiconductor memory, such as ROM. PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device (e.g., via one or more wired connections, one or more wireless connections, or any combination thereof)

Instructions can be directly executable or can be used to develop executable instructions For example, instructions can be realized as executable or non-executable machine code or as instructions in a high-level language that can be compiled to produce executable or non-executable machine code. Further, instructions also can be realized as or can include data. Computer-executable instructions also can be organized in any format, including, but not limited to, routines, subroutines, programs, data structures, objects, modules, applications, applets, functions, and/or the like. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations may be performed by one or more integrated circuits, such as ASICs or FPGAs. In one or more implementations, such integrated circuits may execute instructions that may be stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software may depend upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As may be used in this specification and any claims of this application, the terms “base station,” “receiver.” “computer.” “server,” “processor,” and “memory” may all refer to electronic or other technological devices These terms exclude people or groups of people. For the purposes of the specification, the terms “display” or “displaying” means displaying on an electronic device.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. The term “and/or” as used herein refers to and encompasses any and all possible combinations of one or more of the associated listed items. As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” may each refer to only A, only B. or only C; any combination of A, B, and C; and/or at least one of each of A, B, and C. The terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. When used in the claims, the term “or” is used as an inclusive or and not as an exclusive or. For example, the phrase “at least one of x, y, or z” means any one of x, y, and z, as well as any combination thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As may be used herein, the terms “computer,” “personal computer,” “device,” “computing device,” “router device,” and “controller device” may refer to any programmable computer system that is known or that will be developed in the future. In certain embodiments, a computer will be coupled to a network, such as described herein. A computer system may be configured with processor-executable software instructions to perform the processes described herein. Such computing devices may be mobile devices, such as a mobile telephone, data assistant, tablet computer, or other such mobile device. Alternatively, such computing devices may not be mobile (e.g., in at least certain use cases), such as in the case of server computers, desktop computing systems, or systems integrated with non-mobile components.

As may be used herein, the terms “component,” “module,” and “system,” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

The predicate words “configured to,” “operable to,” “operative to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation or the processor being operative to monitor and control the operation. Likewise, a processor configured to execute code can be construed as a processor programmed to execute code or operable to execute code or operative to execute code.

As used herein, the term “based on” may be used to describe one or more factors that may affect a determination. However, this term does not exclude the possibility that additional factors may affect the determination. For example, a determination may be solely based on specified factors or based on the specified factors as well as other, unspecified factors. The phrase “determine A based on B” specifies that B is a factor that is used to determine A or that affects the determination of A. However, this phrase does not exclude that the determination of A may also be based on some other factor, such as C. This phrase is also intended to cover an embodiment in which A may be determined based solely on B. As used herein, the phrase “based on” may be synonymous with the phrase “based at least in part on.”

As used herein, the phrase “in response to” may be used to describe one or more factors that trigger an effect. This phrase does not exclude the possibility that additional factors may affect or otherwise trigger the effect. For example, an effect may be solely in response to those factors, or may be in response to the specified factors as well as other, unspecified factors. The phrase “perform A in response to B” specifies that B is a factor that triggers the performance of A. However, this phrase does not foreclose that performing A may also be in response to some other factor, such as C. This phrase is also intended to cover an embodiment in which A is performed solely in response to B.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter/neutral gender (e g., her and its and they) and vice versa. Headings and subheadings, if any, are used for convenience only and do not limit the subject disclosure.

While there have been described systems, methods, and computer-readable media for opening vehicle doors with a multifunction switch, many changes may be made therein without departing from the spirit and scope of the subject matter described herein in any way. It should also be noted that while the technologies described herein may be illustrated primarily with respect to control mechanisms of a vehicle, the described technologies can also be implemented in any number of additional or alternative settings or contexts and towards any number of additional objectives. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. It is also to be understood that various directional and orientational terms, such as “left” and “right,” “up” and “down,” “front” and “back” and “rear,” “top” and “bottom” and “side,” “above” and “below,” “length” and “width” and “thickness” and “diameter” and “cross-section” and “longitudinal,” “X-” and “Y-” and “Z-,” and/or the like, may be used herein only for convenience, and that no fixed or absolute directional or orientational limitations are intended by the use of these terms. For example, the components of the apparatus can have any desired orientation. If reoriented, different directional or orientational terms may need to be used in their description, but that will not alter their fundamental nature as within the scope and spirit of the disclosure.

Therefore, those skilled in the art will appreciate that the concepts of the disclosure can be practiced by other than the described embodiments, which are presented for purposes of illustration rather than of limitation.

What is claimed is:

1. A vehicle comprising:
a barrier component;
a compartment component defining a barrier opening; and
a multifunction switch system comprising:
a barrier multifunction switch comprising:
a mechanical interface component that is configured to be moved from a first mechanical switch position to a second mechanical switch position; and
an electrical interface component coupled to the mechanical interface component; and
a latch assembly that is configured to:
enable movement of at least a portion of the barrier component away from the barrier opening in response to movement of the mechanical interface component from the first mechanical switch position to the second mechanical switch position; and
enable movement of at least the portion of the barrier component away from the barrier opening in response to an interface electrical signal being generated by the electrical interface component.

2. The vehicle of claim 1, wherein:
the mechanical interface component is accessible to receive a user mechanical load to move the mechanical interface component from the first mechanical switch position to the second mechanical switch position; and
the electrical interface component is accessible to receive a user electrical load to generate the interface electrical signal.

3. The vehicle of claim 1, wherein:
the electrical interface component is coupled to a front surface of the mechanical interface component; and
a rear surface of the mechanical interface component is accessible to receive a user mechanical load to move the mechanical interface component from the first mechanical switch position to the second mechanical switch position.

4. The vehicle of claim 3, wherein the electrical interface component is accessible to receive a user electrical load to generate the interface electrical signal.

5. The vehicle of claim 1, wherein:
the multifunction switch system further comprises:
a lever pin; and
a cable extending between a first end coupled to the mechanical interface component and a second end coupled to the latch assembly; and
the mechanical interface component is configured to be rotated about the lever pin from the first mechanical switch position to the second mechanical switch position for pulling the first end of the cable in a cable direction.

6. The vehicle of claim 5, wherein the lever pin is coupled to the barrier component.

7. The vehicle of claim 5, wherein the multifunction switch system further comprises a rotary spring configured to rotate the mechanical interface component about the lever pin from the second mechanical switch position to the first mechanical switch position.

8. The vehicle of claim 5, wherein the multifunction switch system further comprises:
a rod; and
a lever actuator configured to extend an end of the rod away from the lever actuator to rotate the mechanical interface component about the lever pin from the first mechanical switch position towards the second mechanical switch position.

9. The vehicle of claim 8, wherein the lever actuator is configured to extend the end of the rod towards the lever actuator when a power supply to the lever actuator is terminated.

10. The vehicle of claim 8, wherein:
the multifunction switch system further comprises an illumination element; and
the lever actuator is configured to illuminate the illumination element when the power supply to the lever actuator is terminated.

11. The vehicle of claim 10, wherein the electrical interface component comprises the illumination element.

12. The vehicle of claim 1, further comprising a power supply configured to provide power to the multifunction switch system.

13. The vehicle of claim 1, further comprising a backup power system configured to:
determine when no power is provided by the power supply; and
then provide power from the backup power system to the barrier multifunction switch.

14. The vehicle of claim 1, wherein the latch assembly is configured to enable movement of at least a portion of the barrier component away from the barrier opening by releasing the portion of the barrier component from a latch of the latch assembly.

15. The vehicle of claim 1, wherein the latch assembly is configured to enable movement of at least a portion of the barrier component away from the barrier opening by moving the portion of the barrier component away from the latch assembly.

16. The vehicle of claim 1, wherein the vehicle is one of the following:
a road vehicle;
a rail vehicle;
a watercraft; or
an aircraft.

17. The vehicle of claim 1, wherein the barrier component is one of the following:
a passenger door barrier component to a passenger compartment component;
a liftgate barrier component to a trunk compartment component;
a hood barrier component to an engine compartment component;
a charging cap barrier component to a charging compartment component;
a fuel barrier component to a fuel compartment component;
a glove box barrier component to a glove box compartment component; or
a console barrier component to a console compartment component.

18. The vehicle of claim 1, wherein the barrier multifunction switch is coupled to the barrier component.

19. A vehicle comprising:
a barrier component;
a compartment component; and
a multifunction switch system comprising:
a barrier multifunction switch comprising:
a mechanical interface component that is configured to be moved from a first mechanical switch position to a second mechanical switch position; and
an electrical interface component coupled to a surface of the mechanical interface component; and
a latch assembly that is configured to enable movement of at least the portion of the barrier component away from the compartment component in response to an interface electrical signal being generated by the electrical interface component.

20. A vehicle comprising:
a barrier component;
a compartment component; and
a multifunction switch system comprising:
a barrier multifunction switch; and
a latch assembly operable to:
move the barrier component away from the compartment component in response to mechanical movement of the barrier multifunction switch; and
move the barrier component away from the compartment component in response to an interface electrical signal generated by the barrier multifunction switch.
